(19) United States
(12) Patent Application Publication
(10) Pub. No.: US 2026/0112378 A1
(43) Pub. Date: Apr. 23, 2026

(54) ENROLLMENT-FREE AUTOMATED SPEECH RECOGNITION IN MULTI-SPEAKER ENVIRONMENTS QUALITY METRICS

(71) Applicant: NVIDIA Corporation, Santa Clara, CA (US)

(72) Inventors: Harishchandra DUBEY, Snohomish, WA (US); Myungjong KIM, Milpitas, CA (US); Oluwatobi OLABIYI, San Francisco, CA (US)

(73) Assignee: NVIDIA Corporation, Santa Clara, CA (US)

(21) Appl. No.: 18/920,531

(22) Filed: Oct. 18, 2024

(51) Int. Cl. G10L 21/02; G10L 15/16

(52) U.S. Cl. CPC G10L 21/02; G10L 15/16

(57) ABSTRACT

The present disclosure relates to systems and methods for enrollment-free automated speech recognition (ASR) in multi-speaker environments. A system can process mixed audio signals containing speech from a target speaker and one or more interfering speakers. By applying acoustic characteristics such as room impulse responses (RIRs) and/or speech-to-interference energy ratios, the system can simulate environments to improve speech separation and recognition accuracy. A neural network model can be trained to identify and transcribe the speech of target speakers and/or secondary speakers, while filtering out interference. The system can update the model using ground-truth text and performance feedback, thereby facilitating real-time or near real-time ASR in multi-speaker environments without requiring predefined speaker data.

### BACKGROUND

Automated speech recognition (ASR) systems for multi-speaker environments often use predefined enrollment speech from a target speaker to train and configure an ASR model. These ASR systems can operate by utilizing the enrollment speech to differentiate the target speaker from other speakers or background noise. However, enrollment-based methods introduce technical limitations including the probability of introducing artifacts into the processed signal, for example, when there are mismatches between the enrollment data and real-time audio signals. In environments where multiple speakers overlap, such as meetings, call centers, or public spaces, these ASR systems can often fail to sufficiently suppress the interfering speech from other speakers, resulting in degraded transcription or diarization accuracy. Additionally, the computational complexity of performing both noise suppression and speech recognition concurrently can cause latency, preventing the ASR system from operating in real-time.

Current techniques can implement speaker encoders that process enrollment speech with ASR encoders that process mixed audio signals. These models, however, face technical challenges when the enrollment speech is noisy or when the contribution of the target speaker to the overall audio signal is minimal. The mismatch between the noisy enrollment data and the actual environment can degrade the word error rate (WER) and result in incomplete or inaccurate transcriptions or diarizations. Furthermore, systems relying on this technique can exhibit speaker-forgetting, where the ASR model can fail to consistently detect and decode the words of the target speaker when their speech represents a small portion of the mixed signal. As a result, the scalability and adaptability of these systems to multi-speaker environments remain limited.

### SUMMARY

Implementations of the present disclosure relate to systems and methods for improving automated speech recognition (ASR) in environments having multiple speakers through enrollment-free techniques. Systems and methods disclosed herein utilize machine learning models, such as neural networks, configured to perform ASR without relying on predefined enrollment speech. These models can be trained to distinguish between target and interfering speakers based on acoustic features (e.g., room impulse response (RIR) data, speech-to-interference energy ratios, reverberation times, and/or any environmental acoustic characteristics), allowing for real-time or near real-time transcription or diarization without relying on pre-recorded samples of the voice of the target speaker. This technique improves the efficiency of speech signal separation and processing, improving the operation of the ASR system for processing multiple simultaneous speech sources.

In some implementations, the system can generate multiple output streams, at least one (e.g., each) corresponding to a different speaker detected within the mixed audio signal. By training neural networks with diverse multi-speaker datasets, the system can isolate and transcribe speech from both the target and secondary speakers in real-time or near real-time. This method reduces computational overhead by minimizing (or reducing) reliance on pre-enrollment procedures and improves performance of various applications (e.g., virtual assistants, in-cabin monitoring or communication, and/or automated call center systems). The analysis of environmental acoustic properties further allows the system to operate across varying room conditions, improving transcription accuracy in various auditory environments.

Some implementation relates to one or more processors including processing circuitry. The one or more processors including processing circuitry are to generate a mixed audio signal based at least on speech of a first speaker and speech of at least one second speaker to which at least one acoustic characteristic of an environment is applied. The one or more processors including processing circuitry are to cause at least one neural network to generate an estimated output based at least on the mixed audio signal. The one or more processors including processing circuitry are to update the at least one neural network based at least on the estimated output and ground-truth text corresponding to the speech of the first speaker.

In some implementations, the at least one acoustic characteristic corresponds to a room impulse response. In some implementations, the room impulse response represents at least one of a direct path or a reflected path in the environment to modify the speech of the first speaker and the speech of the at least one second speaker. In some implementations, the one or more processors including processing circuitry are to cause the at least one neural network to generate a second estimated output including predicted text corresponding to spoken words of the at least one second speaker based at least on the mixed audio signal and the ground-truth text corresponding to the speech of the at least one second speaker.

In some implementations, the at least one neural network includes a first neural network to generate the estimated output and a second neural network to generate the second estimated output. In some implementations, the processing circuitry are to operate the first neural network and the second neural network in parallel. In some implementations, the update of the at least one neural network includes minimizing a cross-entropy loss between the estimated output and the ground-truth text corresponding to the speech of the first speaker. In some implementations, cross-entropy loss is determined based at least on a comparison between predicted text of the at least one neural network and the ground-truth text for the speech of the first speaker.

In some implementations, training data preparation of the at least one neural network includes selecting a first subset of a plurality of speakers in a speech corpus as a plurality of primary speakers. In some implementations, training data preparation of the at least one neural network includes selecting a second subset of the plurality of speakers in the speech corpus as a plurality of secondary speakers. In some implementations, training data preparation of the at least one neural network includes associating a plurality of first speech utterances of the first subset of the plurality of speakers with a primary speaker database. In some implementations, training data preparation of the at least one neural network includes associating a plurality of second speech utterances of the second subset of the plurality of speakers with a secondary speaker database.

In some implementations, the mixed audio signal is generated by applying a speech-to-interference energy ratio to combine selected speech of the first speaker with selected speech of the at least one second speaker. In some implementations, the speech-to-interference energy ratio corresponds to a range. In some implementations, training data preparation of the at least one neural network includes combining a plurality of speech samples of at least one primary speaker with selected portions of speech from a plurality of secondary speakers to generate the mixed audio signal. In some implementations, the mixed audio signal includes the speech-to-interference energy ratio corresponding to a range. In some implementations, the ground-truth text corresponds to the speech of the at least one primary speaker in the mixed audio signal.

Some implementation relates to one or more processors including processing circuitry. The one or more processors including processing circuitry are to receive an audio signal representing target speech of a target speaker and secondary speech of one or more secondary speakers. The one or more processors including processing circuitry are to apply the audio signal as input to at least one neural network to cause the at least one neural network to generate a text representation of the target speech. In some implementations, the at least one neural network is updated based at least on an acoustic characteristic of a plurality of environments and example audio data and example speech data from a plurality of speakers. The one or more processors including processing circuitry are to output, using at least one of a display device or an audio output device, the text representation.

In some implementations, the at least one neural network includes a first neural network to generate the text representation of the target speech and a second neural network to generate a text representation of the secondary speech of at least one secondary speaker of the one or more secondary speakers. In some implementations, the processing circuitry are to operate the first neural network and the second neural network in parallel. In some implementations, the one or more processors including processing circuitry are to apply the audio signal as input to the second neural network to cause the second neural network to generate the text representation of the secondary speech.

In some implementations, the text representation of the target speech includes predicted text corresponding to spoken words of the target speaker based at least on the audio signal. In some implementations, the text representation of the secondary speech includes predicted text corresponding to spoken words of the one or more secondary speakers based at least on the audio signal. In some implementations, the acoustic characteristic corresponds to a room impulse response. In some implementations, the room impulse response represents at least one of a direct path or a reflected path in an environment to modify the target speech of the target speaker and the secondary speech of the one or more secondary speakers.

Some implementations relate to a method. The method includes generating a mixed audio signal based at least on speech of a first speaker and speech of at least one second speaker to which at least one acoustic characteristic of an environment is applied. The method includes causing at least one neural network to generate an estimated output based at least on the mixed audio signal. The method includes updating the at least one neural network based at least on the estimated output and ground-truth text corresponding to the speech of the first speaker.

In some implementations, the at least one acoustic characteristic corresponds to a room impulse response. In some implementations, the room impulse response represents at least one of a direct path or a reflected path in the environment to modify the speech of the first speaker and the speech of the at least one second speaker. In some implementations, method further including causing the at least one neural network to generate a second estimated output including predicted text corresponding to spoken words of the at least one second speaker based at least on the mixed audio signal and the ground-truth text corresponding to the speech of the at least one second speaker.

In some implementations, the at least one neural network includes a first neural network to generate the estimated output and a second neural network to generate the second estimated output. In some implementations, first neural network and the second neural network are operated in parallel. In some implementations, the update of the at least one neural network includes minimizing a cross-entropy loss between the estimated output and the ground-truth text corresponding to the speech of the first speaker. In some implementations, the cross-entropy loss is determined based at least on a comparison between predicted text of the at least one neural network and the ground-truth text for the speech of the first speaker.

In some implementations, training data preparation of the at least one neural network includes selecting a first subset of a plurality of speakers in a speech corpus as a plurality of primary speakers. In some implementations, training data preparation of the at least one neural network includes selecting a second subset of the plurality of speakers in the speech corpus as a plurality of secondary speakers. In some implementations, training data preparation of the at least one neural network includes associating a plurality of first speech utterances of the first subset of the plurality of speakers with a primary speaker database. In some implementations, training data preparation of the at least one neural network includes associating a plurality of second speech utterances of the second subset of the plurality of speakers with a secondary speaker database.

The processors, systems, and/or methods described herein can be implemented by or included in at least one a system. The system can include a control system for an autonomous or semi-autonomous machine. The system can include a perception system for an autonomous or semi-autonomous machine. The system can include a system for performing simulation operations. The system can include a system for performing digital twin operations. The system can include a system for performing light transport simulation. The system can include a system for performing collaborative content creation for 3D assets. The system can include a system for performing deep learning operations. The system can include a system for performing remote operations. The system can include a system for performing real-time streaming. The system can include a system for generating or presenting one or more of augmented reality content, virtual reality content, or mixed reality content. The system can include a system implemented using an edge device. The system can include a system implemented using a robot. The system can include a system for performing conversational AI operations. The system can include a system implementing one or more multi-model language models. The system can include a system implementing one or more large language models (LLMs). The system can include a system implementing one or more small language models (SLMs). The system can include a system implementing one or more vision language models (VLMs). The system can include a system for generating synthetic data. The system can include a system for generating synthetic data using AI. The system can include a system incorporating one or more virtual machines (VMs). The system can include a system implemented at least partially in a data center. The system can include a system implemented at least partially using cloud computing resources.

### BRIEF DESCRIPTION OF THE DRAWINGS

The present systems and methods for enrollment-free automated speech recognition (ASR) in multi-speaker environments are described in detail below with reference to the attached drawing figures, wherein:

FIG. 1 is a block diagram of an example of a system, in accordance with some implementations of the present disclosure;

FIG. 2A is a block diagram of an audio processing pipeline for modeling audio signals, in accordance with some implementations of the present disclosure;

FIG. 2B is a block diagram of an audio processing pipeline for modeling audio signals of a primary speaker and a secondary speaker, in accordance with some implementations of the present disclosure;

FIG. 2C is a block diagram of an audio processing pipeline for modeling audio signals using a plurality of models, in accordance with some implementations of the present disclosure;

FIG. 2D is a block diagram of an audio processing pipeline for modeling audio signals from a plurality of inputs, in accordance with some implementations of the present disclosure;

FIG. 3A is a block diagram of an audio processing pipeline for storing training data, in accordance with some implementations of the present disclosure;

FIG. 3B is a block diagram of an audio processing pipeline for training one or more models, in accordance with some implementations of the present disclosure;

FIG. 4A is a flow diagram of a method of model training to perform automated speech recognition (ASR) in multi-speaker environments, in accordance with some implementations of the present disclosure;

FIG. 4B is a flow diagram of a method of performing automated speech recognition (ASR) in multi-speaker environments, in accordance with some implementations of the present disclosure;

FIG. 5A is a block diagram of an example generative language model system for use in implementing at least some implementations of the present disclosure;

FIG. 5B is a block diagram of an example generative language model that includes a transformer encoder-decoder for use in implementing at least some implementations of the present disclosure;

FIG. 5C is a block diagram of an example generative language model that includes a decoder-only transformer architecture for use in implementing at least some implementations of the present disclosure;

FIG. 6 is a block diagram of an example computing device for use in implementing at least some implementations of the present disclosure; and

FIG. 7 is a block diagram of an example data center for use in implementing at least some implementations of the present disclosure.

### DETAILED DESCRIPTION

This disclosure relates to systems and methods for individualized automated speech recognition (ASR), such as systems and methods of enrollment-free ASR in multiple speaker environments. In various contexts, ASR can be expected to be performed where speaker identities are not available and/or are not clearly mappable to their speech as detected by devices such as microphones. For example and without limitation, in meetings, call centers, vehicle or machine interiors, indoor or outdoor environments, environments with music, podcasts, or TV in the background, or various combinations thereof, the devices that receive sound corresponding to speech from a target speaker can also receive sound corresponding to speech from one or more additional speakers or other background noise sources. For example, ASR can be expected to be performed on mixed signals including speech from multiple speakers.

Some systems use predefined speech of the target speaker, e.g., enrollment speech, to facilitate configuring ASR systems, including machine learning model-based systems, to selectively detect speech from the target speaker. This can include personalized noise suppression approaches, in which an interfering speech of a speaker is removed from the mixed signal, and the resulting signal is provided to the ASR system. However, with personalized noise suppression, speech signals can have artifacts or leakage of segments from interfering speakers. In addition, sufficient latency can result from the computational demands of performing both personalized noise suppression and ASR to prevent the ASR from being performed in real-time or near real-time.

Another technique includes implementing the ASR system with a speaker encoder that receives the enrollment speech as input, and an ASR encoder that receives a mixed signal including the target speaker and interfering speaker speech, along with output of the speaker encoder, along with a decoder that performs ASR for the speech of the target speaker. However, enrollment speech can be noisy, which can cause mismatches and degrade a word error rate. Also, such models can be required to large, which can take significantly more memory and time for computing word predictions. If the target speaker speaks in few segments of the audio, such approaches suffer from speaker-forgetting problems where they miss to decode words spoken by the target speaker.

Systems and methods in accordance with the present disclosure can allow for enrollment-free ASR, including where the ASR is to be performed on audio data that can be from multiple speakers. This can allow for more accurate and/or rapid ASR, such as to allow for ASR to be performed in real-time or near real-time and on audio signals with many speakers. Systems and methods in accordance with the present disclosure can allow for the ASR to be generalized and/or scaled to any speaker and/or multiple speakers.

For example, the system can include a neural network-based machine learning model, such as an encoder-based machine learning model, that is updated (e.g., trained, configured, fine-tuned) based at least on example speech data and example environment data. For example, the example environment data can include room impulse response data. In the inference phase, the machine learning model can receive audio data that can include speech of a target speaker and of one or more secondary speakers, and can output a representation of the speech of the target speaker, such as to output the representation to include the speech of the target speaker and not of the one or more secondary speakers.

In some implementations, the system can cause the at least one neural network to generate a second estimated output including predicted text corresponding to spoken words of the at least one second speaker. For example, the generation of the second estimated output can be based at least on the mixed audio signal and the ground-truth text corresponding to the speech of the at least one second speaker. That is, the neural network can be trained to handle multi-speaker environment and output text corresponding to each speaker. Additionally, the acoustic characteristic can correspond to a room impulse response. For example, the room impulse response can include one or more parameters (e.g., reverberation time, early decay time, and/or reflection coefficients) representing at least one of a direct path or a reflected path of the speech of the first speaker and the at least one second speaker in the environment. In some implementations, the update of the at least one neural network can include minimizing a cross-entropy loss between the estimated output and the ground-truth text corresponding to the speech of the first speaker. For example, the cross-entropy loss can be determined based at least on a comparison between predicted text (e.g., phoneme sequences, sub-word units, and/or character-level outputs) of the at least one neural network and the ground-truth text (e.g., reference transcripts, annotated speech, and/or manual transcriptions) for the speech of the first speaker. That is, by minimizing or reducing the loss, the model(s) can learn to predict the spoken words of the target speaker, thereby reducing transcription or diarization errors by aligning the estimated output with the ground-truth text of the primary speaker.

In some implementations, the system can prepare a training dataset of the neural network(s) by randomly selecting a threshold or percentage of a total speech corpus of speakers as primary speakers. For example, the system can select a first subset of a plurality of speakers in a speech corpus (e.g., a database of recorded speech samples, audio recordings from various speakers, and/or transcribed spoken dialogues) as a plurality of primary speakers. Additionally, the system can select a second subset of the plurality of speakers in the speech corpus as a plurality of secondary speakers. In some implementations, the subset can be different in that no speaker is in common between the subsets. Additionally, the system can associate a plurality of first speech utterances of the selected plurality of primary speakers with a primary speaker database and a plurality of second speech utterances of the selected plurality of secondary speakers with a secondary speaker database. In some implementations, the system can prepare a training dataset of the neural network(s) by combining (or mixing) a plurality of speech samples of at least one primary speaker with selected portions of speech from a plurality of secondary speakers to generate the mixed audio signal. That is, the selected portions can be randomly selected (e.g., random speech segments, utterance fragments, and/or time intervals). Additionally, the mixed audio signal can include a speech-to-interference energy ratio (e.g., between −2 decibels (dB) to 10 dB) corresponding to a range. In some implementations, the ground-truth text can correspond to the speech of the at least one primary speaker in the mixed audio signal.

The system can implement enrollment-free ASR by utilizing acoustic characteristics and real-time (or near real-time) audio features to distinguish between speakers, reducing computational complexity and improving processing efficiency. The system can provide accurate ASR in multi-speaker environments without reliance on pre-recorded speaker samples, allowing the system to perform real-time transcription and other downstream actions in varying acoustic conditions. The system can be implemented in various applications, including but not limited to, in-cabin monitoring systems, interactive kiosks, virtual assistants, and/or call center automation.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, diarization models, transcription models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine. ” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

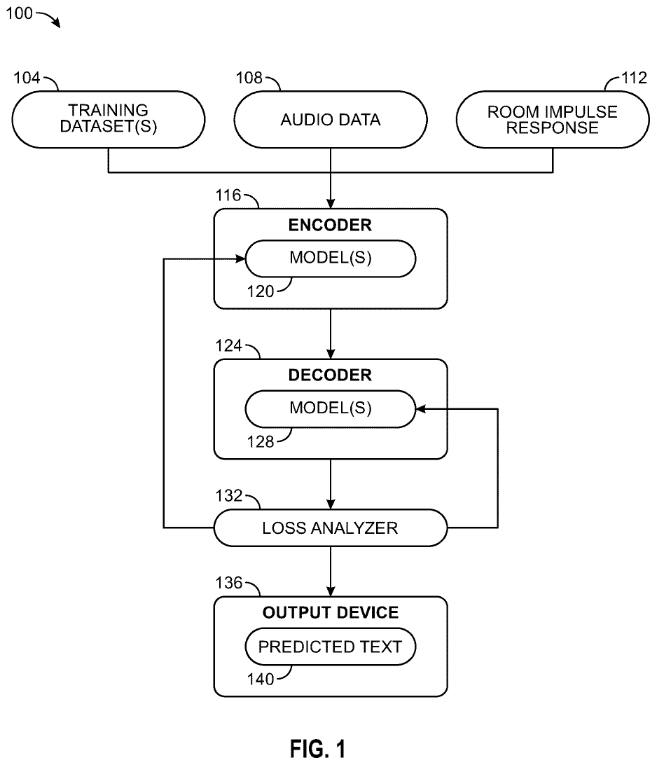

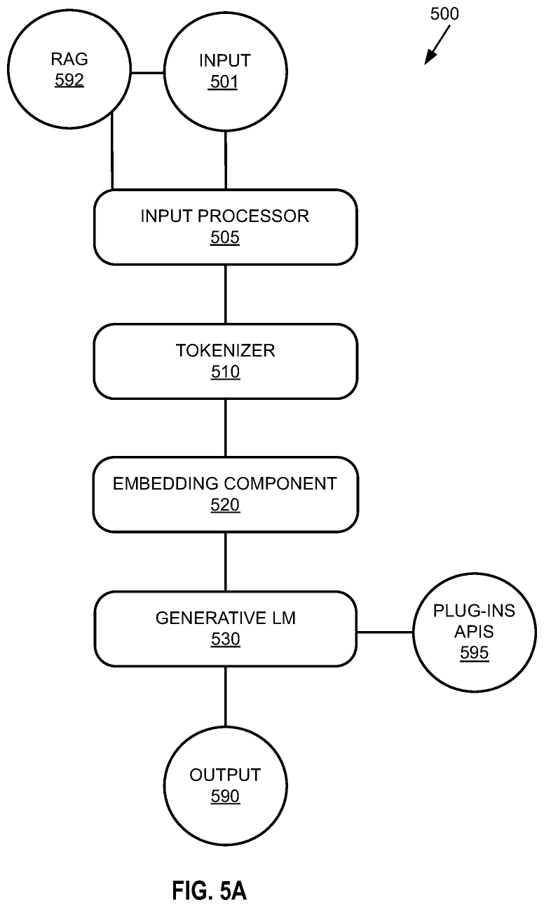

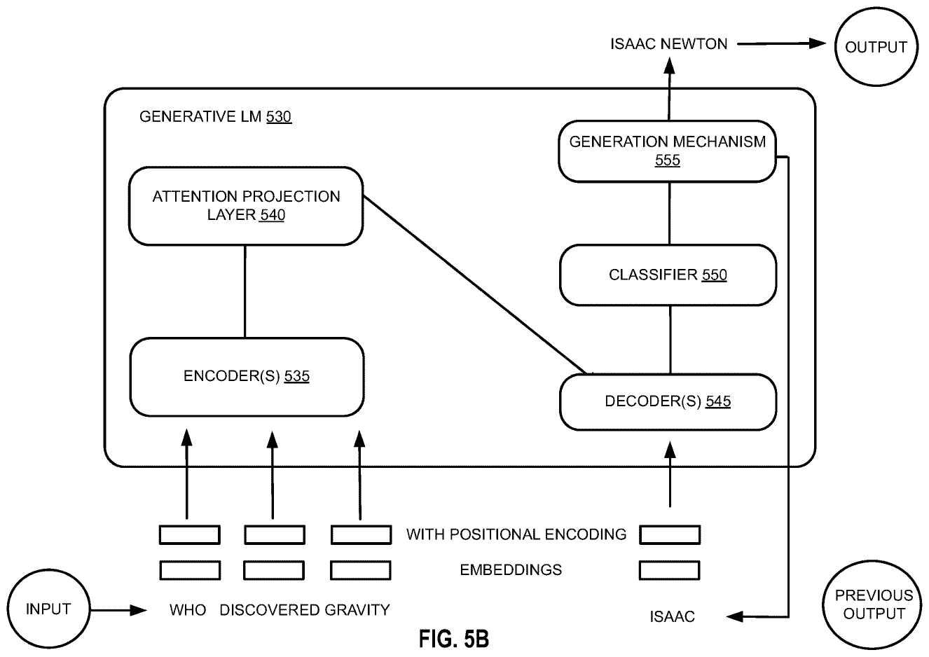

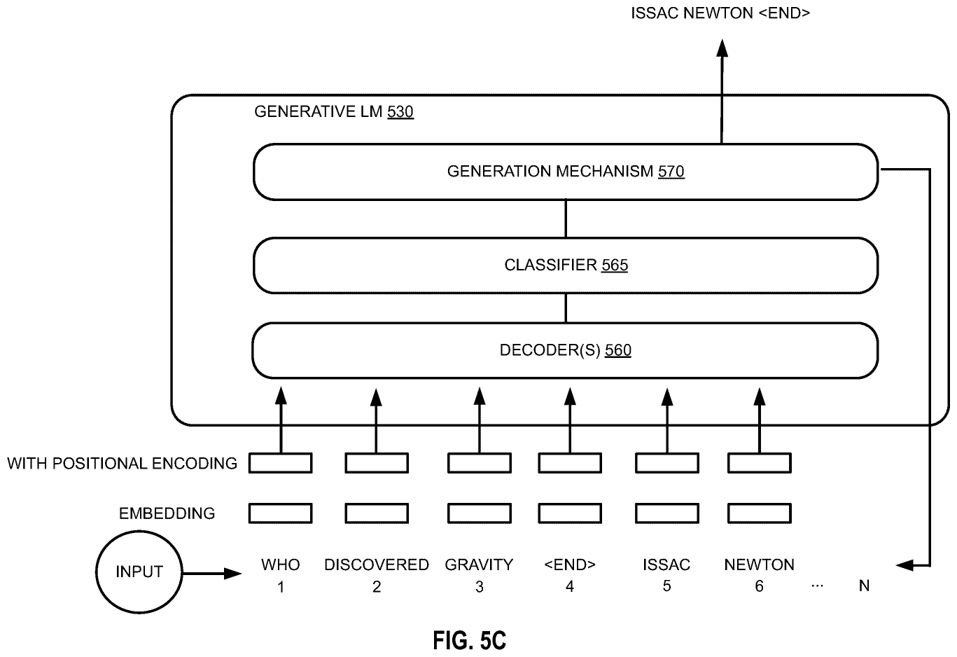

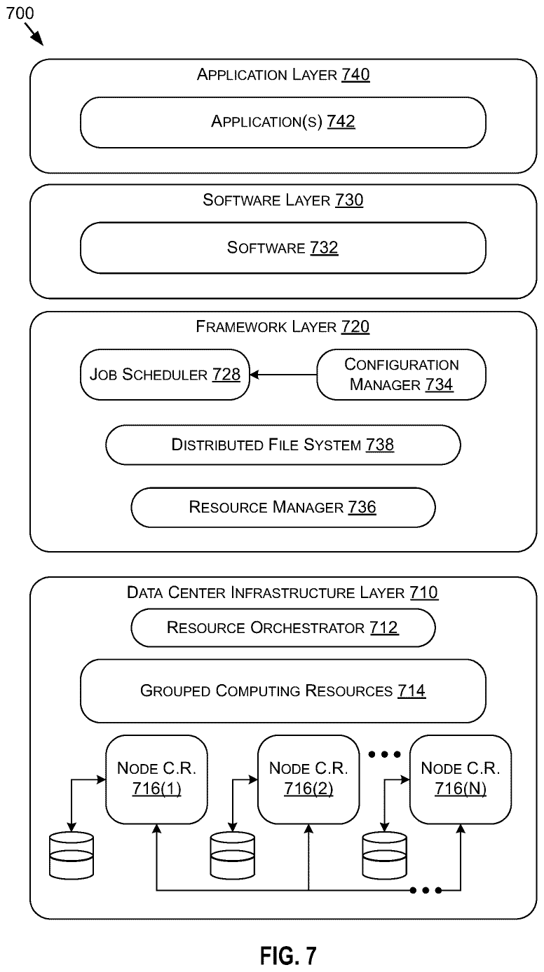

With reference to FIG. 1, FIG. 1 is an example block diagram of a system 100 (e.g., a speech system), in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 500 of FIG. 5A, example generative language model (LM) 530 of FIGS. 5B-5C, example computing device 500 of FIG. 5, and/or example data center 700 of FIG. 7.

The system 100 can implement at least a portion of a speech recognition pipeline, such as an audio processing pipeline, an AI audio pipeline, and/or a speaker identification pipeline. For example, the system 100 can process audio data 108 from one or more sources (e.g., microphones). The audio data 108 from the one or more data sources can be separated into speech segments from multiple speakers and/or decomposed into speaker-specific components, such as target speaker speech and secondary speaker speech, and/or classified based on direct and reflected paths of sound signals. The system 100 can be used to model the audio data 108 (e.g., encode and decode) to predict text and/or speaker for use by any of various systems described herein, including but not limited to call center systems, in-cabin monitoring systems, interactive kiosk systems, virtual assistant systems, surveillance systems, healthcare systems, and/or educational systems.

Generally, the audio processing pipeline (also referred to as an “speaker identification pipeline”) can include operations performed by the system 100. For example, the audio processing pipeline can include any one or more of a preprocessing stage, an encoding stage, a decoding stage, a loss stage, and/or a transmission stage. Each stage of the audio processing pipeline includes one or more components of the system 100 that perform the functions described herein. In some implementations, one or more of the stages can be performed during the training of AI models. Additionally, one or more of the stages can be performed during the inference phase using the AI models.

The system 100 (e.g., implementing the audio processing pipeline) can generate a mixed audio signal (e.g., a signal representative of speech from multiple speakers) based at least on speech of a first speaker (e.g., primary speaker) and speech of at least one second speaker (e.g., secondary speaker) to which at least one acoustic characteristic (e.g., room impulse response (RIR), speech-to-interference energy ratios, reverberation time, and/or any reflection coefficients) of an environment (e.g., room, area, and/or any other space) is applied. In some implementations, implementing the audio processing pipeline can include the system 100 causing at least one neural network (e.g., encoder-decoder) to generate an estimated output (predicted text 140, e.g., text representation, transcript) based at least on the mixed audio signal. Additionally, during training, the system 100 can update the at least one neural network based at least on the estimated output and ground-truth text corresponding to the speech of the first speaker. In some implementations, during implementation and/or operation (e.g., inference) of the neural networks the system 100 can output, using at least one of a display device or an audio output device, the estimated output. This can allow the system 100 to improve the accuracy and efficiency of speech recognition in multi-speaker environments by employing real-time acoustic modeling and dynamic feature extraction.

The training of the encoder 116 and decoder 124 described herein can include tuning (e.g., optimizing, adjusting, modifying) model parameters (e.g., of model(s) 120 and/or model(s) 128) based on loss functions (e.g., cross-entropy loss, mean squared error, Huber loss) determined from predicted text 140 and ground-truth data corresponding to one or more speakers (e.g., primary speaker, secondary speaker, or combinations thereof). The inference phase of operation of the encoder 116 and decoder 124 can include the real-time operation and/or application of pre-trained model weights of the trained models (e.g., model(s) 120, model(s) 128) to output text from live or recorded audio containing multiple speakers, using various metrics for refinement (e.g., confidence scores, signal-to-noise ratios, tracking consistency).

In some implementations, the room impulse response (RIR) 112, audio data 108, and training dataset(s) 104 can be inputs to the audio processing pipeline implemented by system 100. The RIR data 112 can be the acoustic characteristics and/or properties of an environment and can be used to model how speech signals are affected by reflections and reverberation. For example, the RIR data 112 can account for how a voice of a speaker bounces off surfaces. The audio data 108 can include speech signals captured from one or more speakers, including primary and secondary speakers. The training dataset(s) 104 can include speech samples and transcriptions used to train the models (e.g., model(s) 120 and/or model(s) 128). In some implementations, the training dataset(s) 104 can be used to tune the system 100 to recognize speech from multiple speakers under different acoustic conditions. That is, the room impulse response 112, combined with audio data 108, can be used by the models (e.g., model(s) 120 and/or model(s) 128) in the system 100 to generalize and/or perform transcription in real-time and/or recorded audio with multiple speakers and varying environmental conditions.

In some implementations, the preprocessing stage can be the stage in the audio processing pipeline in which the system 100 processes input audio signals from one or more speakers and/or prepares the audio signals for subsequent stages, such as encoding and/or decoding. The system 100 can include one or more acoustic feature extraction components and/or speaker embedding extraction components configured to and/or implemented to process and analyze raw audio data (e.g., mixed or isolated signals). For example, input audio signals from one or more microphones can be analyzed to generate Mel-spectrogram feature vectors, capturing acoustic features such as frequency distribution, amplitude, and/or temporal variation. Additionally, the system 100 can identify speaker-specific characteristics by analyzing voice features, such as vocal pitch, formant frequencies, and/or timbre, to differentiate between speakers, which can include distinguishing the target speaker (e.g., primary speaker) from one or more interfering speakers (e.g., secondary speakers). In this example, acoustic feature vectors and speaker embedding vectors can be extracted in parallel from the audio signal, where at least one (e.g., each) vector can represent different aspects of the speech and speaker data.

In some implementations, the preprocessing stage can include the system 100 performing integration. Integration can include combining the extracted acoustic features and speaker embeddings into a representation (e.g., unified) of the audio signal. That is, the system 100 can combine a plurality of speech samples of at least one primary speaker with selected portions of speech from a plurality of secondary speakers to generate a mixed audio signal. The mixed audio signal can include a speech-to-interference energy ratio corresponding to a range (e.g., −2 dB, 10 dB). Additionally, the ground-truth text (e.g., transcribed text of the primary speaker, reference annotations) can correspond to the speech of the at least one primary speaker in the mixed audio signal. That is, the speech-to-interference energy ratio can be used to determine the balance between speech of the target speaker and background interference.

For example, system 100 can concatenate the Mel-spectrogram features and speaker embedding features at a frame-level to generate a multi-dimensional matrix representation. In this example, the resulting matrix can include rows corresponding to individual time frames and columns corresponding to the combined acoustic and speaker-specific features. This unified representation can be used by the system 100 in subsequent stages (e.g., encoding, decoding) to maintain the distinction between different speakers and verify the speech of a speaker (e.g., primary, secondary) is accurately isolated and processed, while accounting for other speech (e.g., secondary) and environmental noise. In some examples, noise filtering or silence detection can be applied by system 100 to remove various segments of the audio signal (e.g., non-speech portions, low-frequency noise, background chatter, and/or any irrelevant acoustic signals) before encoding.

In some implementations, the preprocessing stage can include the system 100 applying room impulse response (RIR) data 112 to simulate the effects of sound reflections and reverberation in various environments. The system 100 can retrieve RIR data 112 from a data storage (e.g., RIR database) and can apply the RIR data 112 to audio signals from at least one (e.g., each) speaker (e.g., primary speaker, secondary speaker #1, and secondary speaker #2) to account for acoustic conditions present in real-world settings, such as enclosed spaces with reflective surfaces. In this example, at least one (e.g., each) audio signal of the speaker can be modeled with specific (e.g., distinct) RIR data 112 (e.g., RIR1, RIR2) before being combined into a mixed audio signal (e.g., for modeling by the encoder 116 and decoder 124.

In some implementations, the system 100 can apply one or more acoustic characteristics during the preprocessing stage to modify and adjust audio signals from one or more speakers. The acoustic characteristics can include, but are not limited to, room impulse responses (RIR), speech-to-interference energy ratios, reverberation, and reflection properties. The system 100 can retrieve data representing these characteristics from a data storage and/or from a real-time stream and apply it to audio signals to simulate environmental conditions (e.g., to ensure that the audio input reflects real-world scenarios before it is processed further in the audio pipeline). For example, in the preprocessing stage, the system 100 can apply acoustic characteristics to the audio signals from each speaker, including target and interfering speakers. In this example, the system 100 can apply different RIRs or other acoustic models to simulate how sound travels through various environments (e.g., updating the audio signal to improve the separation of target speech from interference). Additionally, the system 100 can apply speech-to-interference energy ratios to adjust the balance between the target speaker and interfering speakers. For example, the system 100 can apply reverberation effects to simulate the persistence of sound in enclosed spaces Additionally, during training of various models (e.g., model(s) 120), model(s) 128), the at least one acoustic characteristic can correspond to a room impulse response. The room impulse response can represent at least one of a direct path (e.g., the unobstructed transmission of sound from the speaker to the microphone) or a reflected path (e.g., sound waves bouncing off walls or surfaces) in the environment (e.g., an enclosed room, an open hall, or any other real-world space) of sound in the environment. The system 100 can use the at least one acoustic characteristic to modify the speech of the first speaker and/or the speech of the at least one second speaker. For example, the system 100 can apply distinct room impulse responses for each speaker to simulate environmental acoustic effects.

In some implementations, the system 100 can generate the mixed audio signal by applying a speech-to-interference energy ratio (e.g., corresponding to range) to combine selected speech of the first speaker with selected speech of the at least one second speaker. That is, the system 100 can adjust the speech-to-interference energy ratio to simulate different levels of interference. The mixed audio signal can be processed by subsequent stages in the pipeline (e.g., trained model 120, trained model 128). The application of RIR data 112 by the system 100 can facilitate the accurate representation of at least one of (e.g., both) the speech of the primary and/or secondary speakers in the features and speaker embeddings extracted during the preprocessing stage.

In some implementations, the preprocessing stage operated by the system 100 can occur using various sub-processes that are used to perform operations on different portions of the audio signal. For example, separate functions, neural networks, and/or algorithms can be employed by system 100 to perform speaker identification, noise filtering, and RIR application independently (or in combination). The outputs of the various sub-processes can be combined and/or aggregated to produce a feature set that can include at least one (e.g., both) speaker-specific data (e.g., embedding vectors) and/or environment-specific data (e.g., RIR-applied features). The preprocessing stage can prepare the input audio for encoding and decoding stages.

The encoding stage can be the stage in the audio processing pipeline in which the system 100 processes audio data, including extracting and/or concatenating (e.g., frame-level Mel-spectrogram feature vectors and/or speaker embedding vectors, prosodic features, pitch contours, and/or any acoustic characteristics) to generate encoded representations. The system 100 can include at least one encoder 116. The encoder 116 can be an automatic speech recognition (ASR) encoder (e.g., FastConformer, Conformer, Transformer-based encoder, CNN-based encoder, and/or any hybrid encoder). The encoder 116 can process mixed audio data from multiple speakers (e.g., primary speaker and secondary speakers) by processing the concatenated frame-level vectors. The concatenation can result in input matrices with a shape determined by frame size and the dimensions of the extracted features (e.g., Mel-spectrogram and speaker embedding vectors, such as, but not limited to, 80 rows corresponding to 8-second buffers, with Dₛₚₖ+Dₘₑₗ columns, prosodic features, spectral envelope characteristics, and/or any temporal features). That is, model 120 can be a neural network trained to process such input data and transform the input data into speaker-specific feature representations. The encoded representations can be used for subsequent decoding stages to generate text transcriptions of the speech of the speaker (e.g., primary speaker, secondary speaker). In some implementations, the encoder 116 can output encoded representations (e.g., concatenated feature vectors, speaker-specific embeddings, temporal audio segments). For example, the encoded data can be used to differentiate between speakers and isolate target speech from interference.

In some implementations, the encoder 116 can maintain, execute, train, and/or update one or more machine-learning models 120 during the encoding stage. These machine-learning model(s) 120 can be trained to perform ASR tasks or processes, such as, but not limited to, extracting and encoding Mel-spectrogram features and/or speaker embeddings to enhance speaker separation in multi-speaker environments. The encoder 116 processes the input buffer (e.g., 80-frame matrix) and encodes features based on speaker-specific audio data and temporal segmentation. The machine-learning model(s) 120 used in the encoder 116 can be trained using training dataset 104 that can include both mixed and isolated audio signals, allowing the model 120 to generalize across various acoustic environments. The encoder 116 can execute the model(s) 120 to produce outputs that can be used as input in the decoding stage. The machine-learning model(s) 120 can be or include a transformer-based model (e.g., a generative pre-trained transformer (GPT) model). The machine-learning model(s) 120 can be or include a speaker recognition model, in some implementations. The encoder 116 can execute the machine-learning model 120 to generate outputs. The encoder 116 can receive data to provide as input to the machine-learning model(s) 120, which can include audio data 108 (e.g., from an audio data source).

The encoder 116 can include at least one neural network (e.g., model 120). The model 120 can consist of an input layer, an output layer, and intermediate layers (e.g., hidden layers) configured for processing concatenated feature vectors. The input layer of the model 120 receives audio features in a specific format (e.g., matrices that combine frame-level Mel-spectrogram and speaker embeddings, prosodic features, spectral envelope parameters, and/or any other acoustic features) which can be pre-processed in the pre-processing stage. The intermediate layers can transform the inputs by enhancing speaker-specific information (e.g., isolate speaker embeddings, improve signal-to-noise ratios). For example, the output layer of model 120 can generate encoded representations of the audio data, which can be used as input to the ASR decoder (e.g., model 128) for transcription. The intermediate layers of the model 120 can be tuned during training to extract the relevant features used to improve the accuracy of speech recognition for the primary speaker and/or other speakers in noisy or multi-speaker environments.

In some implementations, the system 100 can configure (e.g., train, update, fine tune, apply transfer learning to) the model 120 by modifying or updating one or more parameters, such as weights and/or biases, of various nodes of the model 120 responsive to evaluating estimated outputs of the model 120 (e.g., generated in response to receiving training examples in training dataset 104). The encoder 116 can be or include various neural network models, including models that can for operating on or generating data including but not limited to audio data, video data, speech data, text data, or various combinations thereof.

In some implementations, the encoder 116 can be configured (e.g., trained, updated, fine-tuned, has transfer learning performed, etc.) based at least on the training data of the at least one training dataset 104. For example, one or more example mixed audio signals and/or isolated speaker-specific audio signals (e.g., from one or more microphones) of one or more individuals of the training data can be applied (e.g., by the system 100, or in a pre-training process performed by the system 100 or another system) as input to the encoder 116 to cause the encoder 116 to generate an estimated output. The estimated output can be evaluated and/or compared with reference transcriptions (or ground-truth annotations) of the training data that correspond with the one or more example mixed audio signals (e.g., primary speaker, secondary speaker, and/or noise components) and/or isolated audio signals of one or more individuals (e.g., primary speaker, secondary speaker, third speaker, and so on), and the model 120 of the encoder 116 can be updated based at least on the performance evaluation (e.g., precision, recall, F1 score (precision-recall metric)) and/or error metrics (e.g., word error rate (WER), speaker diarization error rate (DER), loss value). For example, based at least on an output of a loss function, one or more parameters (e.g., weights and/or biases) of model 120 of the encoder 116 can be updated. In this example, the loss function can be performed by the backpropagation to output updated model weights and biases.

In some implementations, the decoding stage can be the stage in the audio processing pipeline in which the system 100 can translate encoded representations back into text outputs. The system 100 can include at least one decoder 124. The decoder 124 can include any one or more artificial intelligence models (e.g., machine learning models, supervised models, neural network models, deep neural network models), rules, heuristics, algorithms, functions, or various combinations thereof to perform operations including speech-to-text conversion, such as generating transcriptions from feature vectors. That is, model 128 can be a neural network trained to decode speaker-specific audio features into corresponding text representations. In some implementations, the decoder 124 can output transcribed text (e.g., predicted words, sentence structures, speaker labels, and/or any confidence scores). For example, the decoder can apply language models to refine the generated text. In another example, the decoder can incorporate error-correction algorithms to improve transcription accuracy. In some implementations, the decoder outputs can be provided to the encoder 116 to perform recurrent processing for refinement. Additionally, the decoder outputs can be provided to the loss analyzer 132 to determine (e.g., compute) loss values for further model tuning.

In some implementations, the decoder 124 can maintain, execute, train, and/or update one or more machine-learning models 128 during the decoding stage. In some implementations, the machine-learning model(s) 128 can include any type of speech recognition machine-learning models capable of converting encoded feature vectors into text transcriptions (e.g., transforming speaker embeddings into predicted text outputs) to output high-fidelity transcriptions in multi-speaker environments. For example, the machine-learning model(s) 128 can be trained and/or updated to improve transcription accuracy, among other language processing tasks. The machine-learning model(s) 128 can be or include a transformer-based model (e.g., a generative pre-trained transformer (GPT) model). The machine-learning model(s) 128 can be or include a speech recognition model, in some implementations. The decoder 124 can execute the machine-learning model 128 to generate outputs. The decoder 124 can receive data to provide as input to the machine-learning model(s) 128, which can include the encoder output (e.g., from encoder 116).

The decoder 124 can include at least one neural network (e.g., model 128). The model 128 can include an input layer, an output layer, and/or one or more intermediate layers, such as hidden layers, which can each have respective nodes. That is, the model 128 translates encoded features into text output by processing through its multiple layers. For example, the input layer receives the encoded feature vectors from the encoder 116. For example, the output layer generates the final predicted transcription based on the input features. For example, the intermediate layers can apply attention mechanisms or sequence models to improve transcription quality. The various layers of the model 128 can be used to convert the raw audio features into structured text representations.

In some implementations, the system 100 can configure (e.g., train, update, fine tune, apply transfer learning to) the model 128 by modifying or updating one or more parameters, such as weights and/or biases, of various nodes of the model 128 responsive to evaluating estimated outputs of the model 128 (e.g., generated in response to receiving training examples in training dataset 104). The decoder 124 can be or include various neural network models, including models that can for operating on or generating data including but not limited to audio data, video data, speech data, text data, or various combinations thereof.

In some implementations, the decoder 124 can be configured (e.g., trained, updated, fine-tuned, has transfer learning performed, etc.) based at least on the training data of the at least one training dataset 104. For example, one or more example mixed audio signals and/or individual speaker audio signals of one or more individuals of the training data can be applied (e.g., by the system 100, or in a pre-training process performed by the system 100 or another system) as input to the decoder 124 to cause the decoder 124 to generate an estimated output (e.g., predicted text 140). The system 100 can evaluate and/or compare estimated output with ground-truth transcripts (or reference text) of the training data that correspond with the one or more example mixed audio signals (e.g., primary speaker text, secondary speaker text) and/or isolated audio signals of one or more individuals (e.g., primary speaker, secondary speaker, third speaker, and so on), and the decoder 124 of the decoder 124 can be updated based at least on the evaluation metrics (e.g., BLEU score, ROUGE score, perplexity) and/or performance feedback (e.g., accuracy, speaker identification precision, text alignment). For example, based at least on an output of the loss function, one or more parameters (e.g., weights and/or biases) of model 128 of the decoder 124 can be updated. In this example, the loss function can be performed by the gradient descent optimizer to output minimized loss values for enhanced transcription accuracy.

In some implementations, a first model 120 can be trained and implemented for one or more primary speakers. That is, the first model 120 can be trained using audio signals corresponding to target speech from primary speakers, which can be used to generate speaker-specific representations. For example, during the encoding stage, the first model 120 can process audio signals and extract feature vectors specific to the speech characteristics of a primary speaker. In this example, the output can be a set of encoded features representing the speech of the primary speaker. Additionally, the training can include the decoder 124 tuning the model 120 based on speaker identification accuracy and transcription quality. For example, the first model 120 (e.g., neural network) can generate speaker embeddings that improves the first model 120 at identifying the primary speaker from background noise and secondary speakers. That is, the first model 120 can be fine-tuned to improve performance on processing regarding primary speaker speech recognition in multi-speaker environments.

In some implementations, a second model 120 can be trained and implemented for one or more secondary speakers. That is, the second model 120 can be trained using audio signals corresponding to speech from secondary speakers, which can be used to generate speaker-specific representations for secondary speech. For example, during the encoding stage, the second model 120 can process audio signals and extract feature vectors related to the speech characteristics of one or more secondary speakers. In this example, the output can be a set of encoded features representing the speech of the secondary speaker. Additionally, the training performed by the decoder 124 can include tuning the model based on metrics, such as, but not limited to, speaker separation accuracy and transcription consistency for secondary speakers. For example, the second model 120 (e.g., neural network) can generate embeddings that improves the second model 120 at identifying the secondary speakers in the presence of primary (or dominant) speaker speech. That is, the second model 120 can be tuned to improve the accuracy of secondary speaker recognition in various audio environments.

In some implementations, a first model 128 can be trained and implemented for one or more primary speakers. That is, the first model 128 can be trained to decode feature vectors corresponding to speech of the primary speaker into textual transcriptions (e.g., predicted text 140). For example, during the decoding stage, the first model 128 can receive the encoded representations from the first model 120 and generate text corresponding to the speech of the primary speaker. In this example, the output can be predicted text 140 representing the words spoken by the primary speaker. Additionally, the training can include the system 100 tuning the model based on transcription accuracy and alignment with reference text (e.g., ground-truth text). That is, the ground-truth text (e.g., transcribed text of a primary speaker, reference annotations) can correspond to the speech of the at least one primary speaker in the mixed audio signal. For example, the first model 128 (e.g., neural network) can improve its performance by minimizing or reducing errors in word recognition for primary speakers. That is, the first model 128 can be fine-tuned to transcribe speech from primary speakers in noisy or multi-speaker environments.

In some implementations, a second model 128 can be trained and implemented for one or more secondary speakers. That is, the second model 128 can be trained to decode feature vectors corresponding to speech of the secondary speaker into textual transcriptions (e.g., predicted text 140). For example, during the decoding stage, the second model 128 can process the encoded representations from the second model 120 and generate text corresponding to the speech of the secondary speaker. In this example, the output can be predicted text representing the words spoken by the secondary speaker. Additionally, the training can include the system 100 tuning the model based on evaluation metrics, such as, but not limited to, word error rate and speaker separation accuracy. For example, the second model 128 (e.g., neural network) can minimize or reduce transcription errors for secondary speakers. That is, the second model 128 can be tuned and/or optimized to transcribe secondary speaker speech in multi-speaker environments.

In some implementations, the primary speaker model (e.g., referred to herein as a model for processing primary speaker data) can include the first model 120 and the first model 128. During an inference phase, the primary speaker model can apply an audio signal as input to the primary speaker model to cause the plurality of neural networks to generate a text representation of the target speech. For example, an audio signal representing the target speech of a target speaker and secondary speech of one or more secondary speakers can be received and/or generated by the system 100. In this example, during an inference phase, the primary speaker model can output, using at least one of a display device or an audio output device (e.g., output device 136), the text representation (e.g., predicted text 140). Additionally, during a training phase, the primary speaker model can cause the plurality of neural networks to generate an estimated output based at least on an mixed audio signal. For example, a mixed audio signal can be generated and/or received by the system 100 based at least on speech of a first speaker and speech of at least one second speaker to which at least one acoustic characteristic of an environment is applied. In this example, during a training phase, the primary speaker model can update the at least one neural network based at least on the estimated output and ground-truth text corresponding to the speech of the first speaker.

In some implementations, the secondary speaker model (e.g., referred to herein as a model for processing data of one or more secondary speakers) can include the first model 120 and the first model 128. During an inference phase, the secondary speaker model can apply an audio signal as input to the secondary speaker model to cause the plurality of neural networks to generate a text representation of the secondary speech. For example, an audio signal representing the secondary speech of one or more secondary speakers and target speech of a target speaker can be received and/or generated by the system 100. In this example, during an inference phase, the secondary speaker model can output, using at least one of a display device or an audio output device (e.g., output device 136), the text representation (e.g., predicted text 140) of the speech of the secondary speaker. Additionally, during a training phase, the secondary speaker model can cause the plurality of neural networks to generate an estimated output based at least on the mixed audio signal. For example, a mixed audio signal can be generated and/or received by the system 100 based at least on speech of a secondary speaker and speech of at least one primary speaker to which at least one acoustic characteristic of an environment is applied. In this example, during a training phase, the secondary speaker model can update the at least one neural network based at least on the estimated output and ground-truth text corresponding to the speech of the secondary speaker. Thus, the plurality of neural networks can include a first neural network to generate the estimated output (e.g., for a primary or target speaker) and a second neural network to generate the second estimated output (e.g., for a secondary speaker or group of secondary speakers). Additionally, the operation of the first neural network (e.g., primary speaker model) and the second neural network (e.g., secondary speaker model) can occur in parallel.

In some implementations, the loss stage can be the stage in the audio processing pipeline where the system 100 computes and analyzes one or more loss values for neural network models (e.g., model(s) 120, model(s) 128). The loss analyzer 132 can calculate loss values based on the difference between the predicted text 140 and the ground-truth text corresponding to one or more speakers (e.g., primary speaker, secondary speaker). The loss values can be used to adjust parameters (e.g., weights, biases) of the models (e.g., model(s) 120, model(s) 128) during training to improve performance in speech recognition accuracy. For example, the system 100 can determine loss functions such as cross-entropy loss or mean squared error and apply backpropagation to update model parameters. In some implementations, the loss analyzer 132 can minimize a cross-entropy loss between the estimated output (e.g., predicted text) and the ground-truth text corresponding to the speech of the first speaker (e.g., target, primary). That is, the cross-entropy loss can be determined based at least on a comparison between predicted text of the at least one neural network and the ground-truth text for the speech of the first speaker. For example, the loss analyzer 132 can compute speaker-specific losses to optimize the models for multi-speaker scenarios. In this example, the loss values can be aggregated and used to adjust the learning rates dynamically during the training phase.

In some implementations, the loss analyzer 132 can track the performance of the models (e.g., model(s) 120, model(s) 128) during training by monitoring loss values and adjusting settings, such as learning rates, based on the monitored values. That is, the loss analyzer 132 can update the models to improve performance in differentiating between speakers in overlapping speech scenarios (e.g., by minimizing errors in speaker identification and transcription accuracy). For example, the output from the loss analyzer 132 can be inputted into the models (e.g., as input into model 120 to improve encoding processes and/or as input into model 128 to improve the generation of text transcriptions) to refine the modeling (e.g., processing, analyzing) of mixed audio signals in multi-speaker environments.

In some implementations, the transmission stage can be the stage in the audio processing pipeline where the system 100 outputs the predicted text 140 to the output device 136. The predicted text 140 can be generated from processed audio data 108 and can be transmitted to the output device 136 (e.g., a display, a user interface, an API for downstream applications, and/or any other output interface). For example, the output device 136 can display the predicted text visually or output it through an audio interface. The predicted text 140 can also contain speaker labels indicating the speech segments of the primary speaker and secondary speakers. In some implementations, the transmission stage can include further processing, such as applying error-correction algorithms or refining the predicted text with language models. That is, the predicted text 140 can include additional details such as speaker identifiers or timestamps to distinguish between speakers. The transmission stage can make available the final transcription output for downstream systems, such as, but not limited to, virtual assistants, transcription services, customer support systems, automated response systems, and/or any real-time communication platforms.

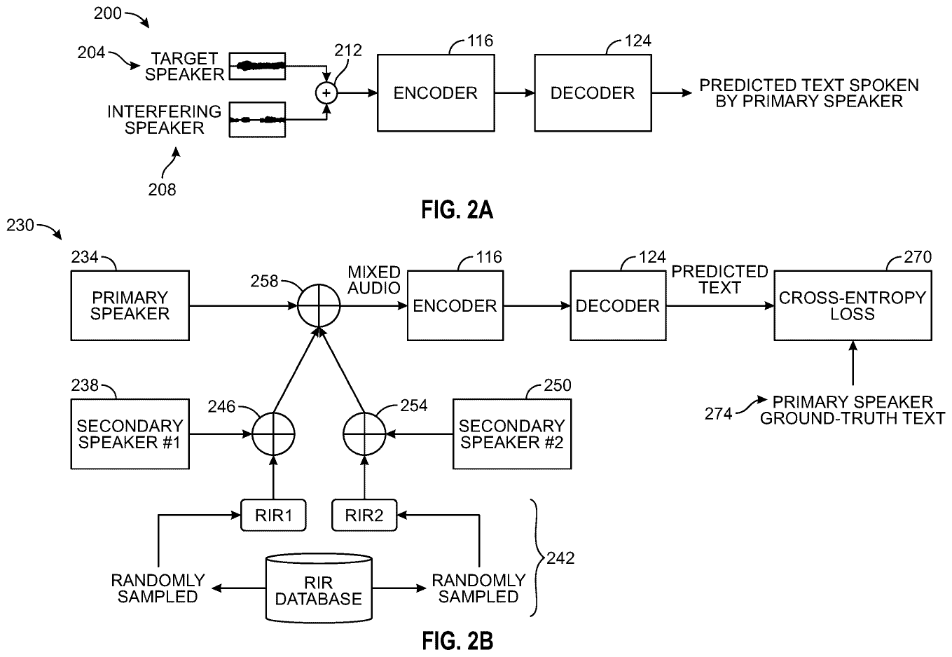

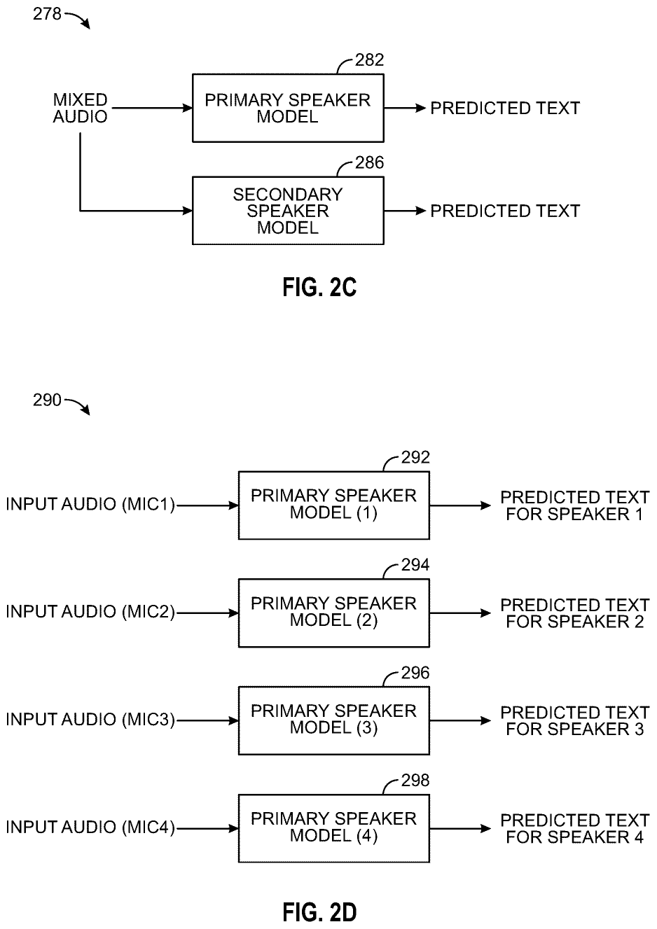

Now referring to FIG. 2A, a block diagram of an audio processing pipeline 200 for modeling audio signals, in accordance with some implementations of the present disclosure. The system 100 of FIG. 1 can implement and perform the operations of the audio processing pipeline 200. That is, audio signals from a target speaker 204 and an interfering speaker 208 can be received. The audio signals from the target speaker 204 and the interfering speaker 208 can be combined at 212 (e.g., by summing, concatenating, applying signal mixing, applying noise filtering, applying time-domain or frequency-domain transformations, and/or a combination of these methods) to generate a mixed audio signal. The mixed audio signal can be input into the encoder 116 to extract encoded representations of the audio data. The encoded data can be inputted in the trained decoder 124, which processes the encoded representations to generate predicted text corresponding to the target speaker 204. The predicted text can represent only the speech of the target speaker 204, with the contribution from the interfering speaker 208 filtered out during the encoding and decoding stages.

Now referring to FIG. 2B, a block diagram of an audio processing pipeline 230 for modeling audio signals of a primary speaker and a secondary speaker, in accordance with some implementations of the present disclosure. The system 100 of FIG. 1 can implement and perform the operations of the audio processing pipeline 230. In some implementations, the system 100 can receive audio inputs corresponding to speech from the primary speaker 234 and secondary speakers (e.g., secondary speaker #1, 238, and secondary speaker #2, 250). The audio signal from the primary speaker 234 can be combined with the audio signal from secondary speaker #1, 238 at 246, and the audio signal from secondary speaker #2, 250 can be combined at 254. Room impulse responses (RIR1 and RIR2), retrieved from the RIR database 242, can be applied to the respective audio signals before combining (e.g., mixing) occurs. The RIR1, RIR2 can be independent of the audio signals received from the various speakers; this can allow the system 100 to configure the encoder 116 and/or decoder 124 to account for acoustic characteristics of a wide variety of environments, such as to learn to distinguish speech information from environment effects on audio. The mixed audio signal, including of the speech of the primary speaker and the speech of the secondary speaker with applied RIRs, can be processed by the encoder 116. The encoded output can be taken as input by the decoder 124 to generate predicted text. The predicted text can be analyzed against the ground-truth text 274 of the primary speaker, with the cross-entropy loss function 270 used to determine an error in transcription of the one or more models (e.g., neural networks). The cross-entropy loss value can be used to adjust the parameters of the encoder 116 and the decoder 124.

Now referring to FIG. 2C, a block diagram of an audio processing pipeline 278 for modeling audio signals using a plurality of models, in accordance with some implementations of the present disclosure. In FIG. 2C, the system 100 of FIG. 1 can include a primary speaker model 282 and a secondary speaker model 286 (e.g., each having respective encoder-decoder models, such as model(s) 120 and model(s) 128 of FIG. 1). The mixed audio signal, including speech from both a primary speaker and one or more secondary speakers, can be provided as input to both the primary speaker model 282 and the secondary speaker model 286. At least one (e.g., each) model can process the mixed audio signal and generate predicted text corresponding to the speech of the primary speaker and secondary speakers, respectively. That is, the primary speaker model 282 can generate predicted text specific to the speech of the primary speaker and the secondary speaker model 286 can output predicted text corresponding to the secondary speakers. In this implementation, the system 100 operates in parallel to process multiple speakers, isolating and transcribing the speech of at least one (e.g., each) speaker into specific and/or distinct text outputs.

Now referring to FIG. 2D, a block diagram of an audio processing pipeline 290 for modeling audio signals from a plurality of inputs, in accordance with some implementations of the present disclosure. FIG. 2D depicts an example in which the system 100 of FIG. 1 receives multiple audio inputs from different sources (e.g., microphones, audio sensors, recording devices, and/or any other audio capture devices). At least one (e.g., each) input audio signal (e.g., MIC1, MIC2, MIC3, MIC4) can be processed by a separate instance of, for example, the primary speaker model 292, 294, 296, 298. For example, input audio from MIC1 can be processed by primary speaker model 292. In this example, the primary speaker model 292 can generate predicted text for Speaker 1. Similarly, input audio from MIC2, MIC3, and MIC4 can processed by primary speaker models 294, 296, and 298, respectively, at least one (e.g., each) generating predicted text for the corresponding speaker (e.g., Speaker 2, Speaker 3, Speaker 4).

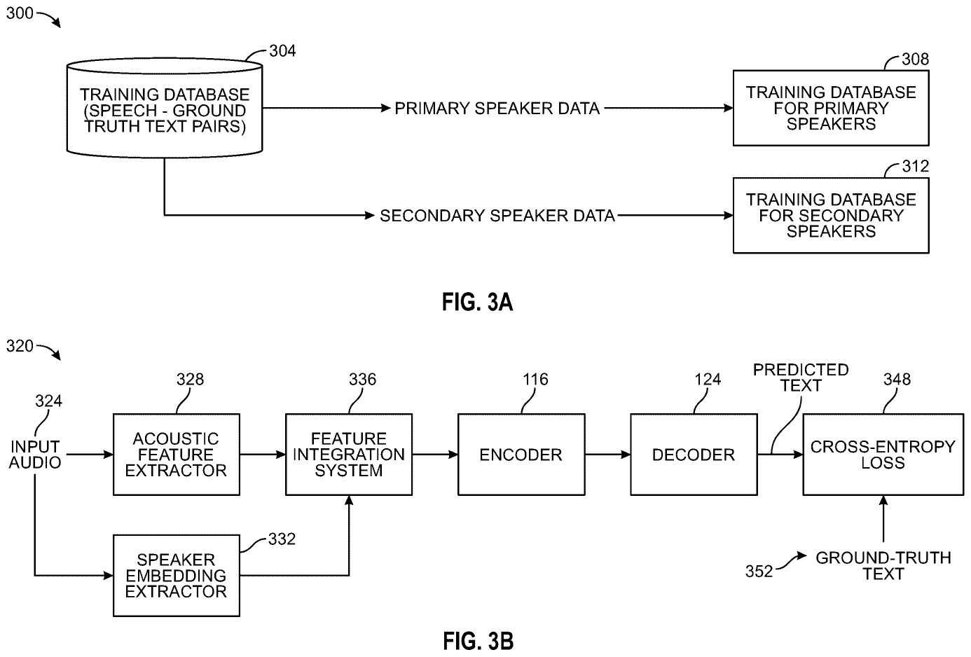

Now referring to FIG. 3A, a block diagram of an audio processing pipeline 300 for storing training data, in accordance with some implementations of the present disclosure. The system 100 of FIG. 1 can store speech data and corresponding ground-truth text pairs in a training database 304. The training database 304 can be divided or categorized into primary speaker data and secondary speaker data to train models (e.g., primary speaker model, secondary speaker model) for at least one (e.g., each) speaker category. For example, the system 100 can randomly select 50% of the total speech corpus to designate as primary speakers, and the remaining 50% designated as secondary speakers. In some implementations, this random selection is performed by applying a random number generator with a seeded value. Once a speaker is selected as a primary speaker, all the speakers speech utterances can be stored or moved to store in a training dataset (e.g., training dataset 104) in a training database 308 (e.g., data storage, such as a sub-database of training database 304) for primary speakers. Additionally, the other speakers can be stored or moved to store in a training dataset (e.g., training dataset 104) in a training database 312 (e.g., data storage, such as a sub-database of training database 304) for secondary speakers. In some implementations, there can be no overlap between the primary and secondary speaker databases. For example, during training dataset 104 preparation, the system 100 can select a first subset of a plurality of speakers in a speech corpus as a plurality of primary speakers. Additionally, the system 100 can select a second subset of the plurality of speakers in the speech corpus as a plurality of secondary speakers. In this example, the system 100 can associate a plurality of first speech utterances of the first subset of the plurality of speakers with a primary speaker database. Additionally, the system can associate a plurality of second speech utterances of the second subset of the plurality of speakers with a secondary speaker database.

Now referring to FIG. 3B, a block diagram of an audio processing pipeline 320 for training one or more models, in accordance with some implementations of the present disclosure. The system 100 of FIG. 1 can process input audio 324 through an acoustic feature extractor 328 (e.g., Mel-spectrogram speech features) to generate feature vectors (e.g., Mel-spectrograms) and through a speaker embedding extractor 332 (e.g., frame-level speaker embedding extractor) to generate speaker-specific embeddings. The extracted features can be integrated in a feature integration system 336, combining speaker embeddings and acoustic features for further processing. The encoder 116 can receive the integrated features to output encoded representations of the input audio, which can then be decoded by the decoder 124 into predicted text. During training, the predicted text can compared with ground-truth text 352, and a cross-entropy loss 348 can be calculated based on the comparison. The system 100 can use the loss values to update model parameters during training, refining the ASR models (e.g., ASR encoder model, ASR decoder model) to improve transcription accuracy.

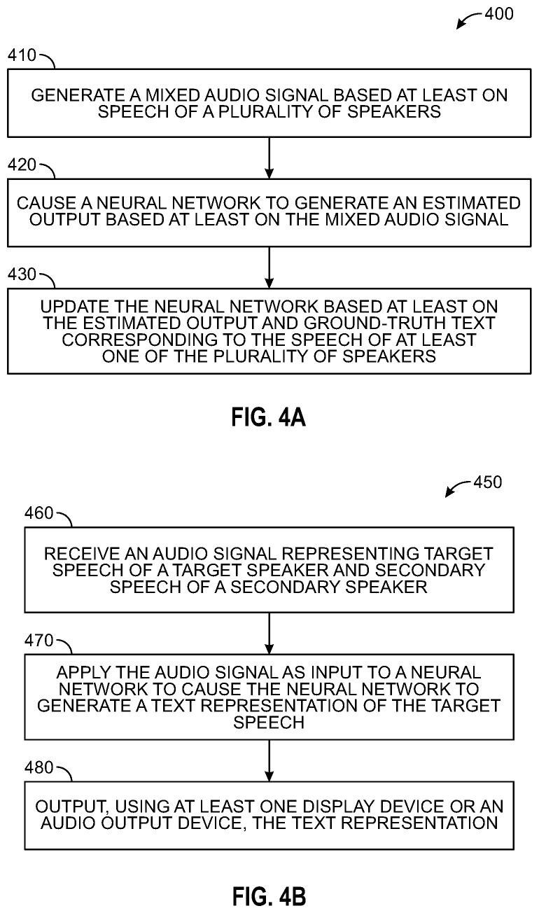

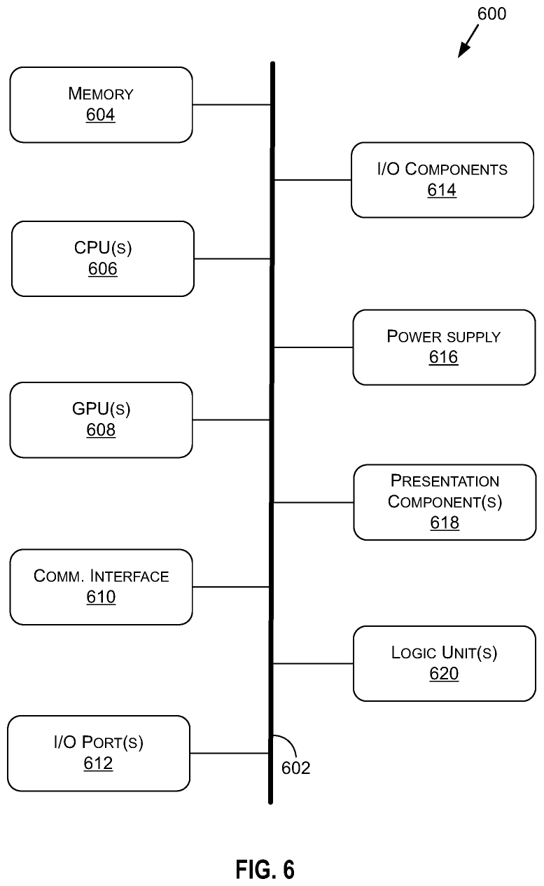

With reference to FIGS. 4A-4B, an example flow diagram illustrating a method for training to perform and performing automated speech recognition (ASR) in multi-speaker environments, in accordance with some implementations of the present disclosure, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 5A-5C), one or more computing devices or components thereof (e.g., as described in FIG. 6), and/or one or more data centers or components thereof (e.g., as described in FIG. 7).

Now referring to FIG. 4A, at least one (e.g., each) block of method 400, described herein, includes a computing process that can be performed using any combination of hardware, firmware, and/or software. For example, various functions can be carried out using one or more processors executing instructions stored in one or more memories. The method 400 can also be embodied as computer-usable instructions stored on computer storage media. The method 400 can be provided by a standalone application, a service or hosted service (standalone or in combination with another hosted service), as a microservice via an application programming interface (API), a plug-in to another product, and/or integrated within a software platform, to name a few. In addition, method 400 is described, by way of example, with respect to the system of FIG. 1. However, this method 400 can additionally or alternatively be executed by any one system, or any combination of systems, including, but not limited to, those described herein.

FIG. 4A is a flow diagram showing a method 400 for generating, causing, and/or updating operations, in accordance with some implementations of the present disclosure. Various operations of method 400 can relate to improving the efficiency and accuracy of automated speech recognition (ASR) in multi-speaker environments. Existing systems often rely on predefined enrollment speech or static processing techniques, which can result in degraded performance in complex or multi-speaker acoustic conditions. The existing technological problems can arise when these systems fail to separate overlapping speech signals or adapt to varying environmental acoustic characteristics, leading to inaccurate transcription and increased computational complexity. Method 400 of FIG. 4A can address these technological problems by implementing an encoder/decoder model(s) that can generate predictions based at least on mixed audio signals of multiple speakers, apply acoustic characteristics of the environment, and perform neural network processing in real-time (or near real-time) to refine speech recognition output, thereby improving accuracy and computational efficiency.

The method 400, at block 410, includes generating a mixed audio signal based at least on speech of a first speaker (e.g., primary or target speaker) and speech of at least one second speaker (e.g., one or more secondary speakers) to which at least one acoustic characteristic of an environment (e.g., room impulse response, reverberation time, reflection coefficients, early decay time) is applied. In some implementations, the mixed audio signal can include speech of a primary speaker combined with (e.g., by mixing, concatenating, and/or overlaying) secondary speaker(s) speech. The processing circuits can apply filtering and normalization to balance the audio signal. The speech can be convolved with RIR(s) such that the spatial characteristics of the environment can be simulated. That is, generating the mixed audio signal can include the processing circuits applying convolution operations to model the acoustic properties of the environment. For example, the processing circuits can adjust the energy ratio between the primary and secondary speaker(s) to maintain a specified speech-to-interference ratio.

In some implementations, the at least one acoustic characteristic corresponds to a room impulse response (RIR). That is, the RIR can be used by the processing circuits to model the acoustic characteristics of the environment, including direct and reflected paths of speech signals. For example, the RIR can be used model how sound travels in a specific room, including how the speech reflects off surfaces. In some implementations, the room impulse response can represent at least one of a direct path or a reflected path in the environment to modify the speech of the first speaker and the speech of the at least one second speaker. That is, the RIR can adjust the audio signal based on how it reflects off walls or other surfaces, simulating real-world environments. For example, the processing circuits can apply different RIRs for different speakers to simulate multiple sound sources in a room. In some implementations, the mixed audio signal can be generated by applying a speech-to-interference energy ratio (e.g., how much the speech of the secondary speaker interferes with the speech of the primary speaker) to combine selected (e.g., randomly, based on pre-configured rules, and/or based on real-time data) speech of the first speaker with selected speech of the at least one second speaker, the speech-to-interference energy ratio corresponding to a range (e.g., between −2 dB and 10 dB).

The method 400, at block 420, includes causing at least one neural network (e.g., using an encoder-decoder framework or architecture, including one or more models) to generate an estimated output (e.g., predicted text) based at least on the mixed audio signal. That is, causing can include processing the mixed audio signal through the neural network models to produce a text representation of the speech of the primary speaker. In some implementations, a first neural network of an encoder (e.g., ASR encoder) can process the input audio data and generate intermediate representations of the mixed signal. That is, the encoder processes the concatenated input vectors to output encoded representations. For example, the encoder can transform the speech data into a structured format suitable for decoding. Additionally, a second neural network of a decoder (e.g., ASR decoder) can convert the encoded representations into text corresponding to the speech of the primary speaker. That is, the decoder interprets the encoded representations to output the predicted text. For example, the decoder can generate a transcription that aligns with the speech of the primary speaker. In some implementations, the encoder-decoder models can be a single neural network that can perform both encoding and decoding operations in a unified model. That is, the single neural network can generate predicted text from the mixed audio input without separating the encoding and decoding processes.

The method 400, at block 430, includes updating (e.g., model training, for example using cross-entropy loss, mean squared error, Huber loss, and/or any error metric) the at least one neural network based at least on the estimated output and ground-truth text (e.g., manual transcription of speech of the primary speaker, labeled datasets, audio-text pairs) corresponding to the speech of the first speaker. That is, the model training can include comparing the predicted text to the ground-truth text and adjusting the model parameters to minimize errors. For example, the processing circuits can backpropagate the loss through the network to update weights and biases. In another example, the processing circuits can adjust learning rates dynamically based on loss reduction trends.

In some implementations, the update of the at least one neural network can include minimizing a cross-entropy loss between the estimated output and the ground-truth text corresponding to the speech of the first speaker. That is, by minimizing the loss, the model(s) can learn to predict the spoken words of the target speaker, thereby reducing transcription errors by aligning the estimated output with the ground-truth text of the primary speaker. For example, the cross-entropy loss can be determined based at least on a comparison between predicted text of the at least one neural network and the ground-truth text for the speech of the first speaker. In this example, the processing circuits can adjust the model parameters to improve performance during a next iteration of training.

In some implementations, method 400 can further include causing the at least one neural network to generate a second estimated output. The second estimated output can include predicted text corresponding to spoken words of the at least one second speaker based at least on the mixed audio signal and the ground-truth text corresponding to the speech of the at least one second speaker. For example, the second estimated output can represent the transcription of the secondary speaker in a multi-speaker scenario. That is, the neural network can be trained and/or updated to process a multi-speaker environment and output text corresponding to at least one (e.g., each) speaker. The neural networks can operate in parallel to process speech signals simultaneously.

In some implementations, the at least one neural network can include a first neural network to generate the estimated output and a second neural network to generate the second estimated output. For example, processing circuitry can operate the first neural network and the second neural network in parallel such that at least one (e.g., each) neural network can be tuned to recognize the speech of a different speaker. That is, the processing circuits can employ two neural networks. The first neural network can process speech of the primary speaker and a second neural network can process speech of the secondary speakers. For example, the primary network can process on the speech of the primary speaker and the secondary network process the interfering speech components.

In some implementations, training data preparation of the at least one neural network can include the processing circuits randomly selecting a percentage of total speech corpus speakers as primary speakers. For example, the processing circuits can select a first subset of a plurality of speakers in a speech corpus as a plurality of primary speakers. In this example, the processing circuits can also select a second subset of the plurality of speakers (e.g., no speaker is common between the subset of primary speakers and the subset of secondary speakers, randomly assigned, and/or algorithmically determined) in the speech corpus as a plurality of secondary speakers. Additionally, the processing circuits can associate a plurality of first speech utterances of the first subset of the plurality of speakers with a primary speaker database (e.g., a first training data subset of a training dataset stored in a data storage). In some implementations, the processing circuits can associate a plurality of second speech utterances of the second subset of the plurality of speakers with a secondary speaker database. That is, in some implementations, the secondary speaker database can be part of the same database as the primary speaker database but can be separated by a predefined threshold for training (e.g., a first training data subset of a training dataset stored in a data storage).

In some implementations, the training data preparation of the at least one neural network can include the processing circuits combining a plurality of speech samples of at least one primary speaker with selected portions of speech from a plurality of secondary speakers to generate the mixed audio signal. That is, the processing circuits can generate mixed audio signals during training by combining speech samples from primary speakers with inference from secondary speakers as specified speech-to-inference energy ratios. For example, the speech-to-interference energy ratio corresponding to a range and the ground-truth text can correspond to the speech of the at least one primary speaker in the mixed audio signal.

Now referring to FIG. 4B, at least one (e.g., each) block of method 450, described herein, includes a computing process that can be performed using any combination of hardware, firmware, and/or software. For example, various functions can be carried out using one or more processors executing instructions stored in one or more memories. The method 450 can also be embodied as computer-usable instructions stored on computer storage media. The method 450 can be provided by a standalone application, a service or hosted service (standalone or in combination with another hosted service), as a microservice via an application programming interface (API), a plug-in to another product, and/or integrated within a software platform, to name a few. In addition, method 450 is described, by way of example, with respect to the system of FIG. 1. However, this method 450 can additionally or alternatively be executed by any one system, or any combination of systems, including, but not limited to, those described herein.

FIG. 4B is a flow diagram showing a method 400 for generating, causing, and/or updating operations, in accordance with some implementations of the present disclosure. Various operations of method 450 can relate to improving the accuracy and efficiency of audio processing pipelines by improving real-time inference based on dynamic acoustic characteristics. Existing systems often rely on static models or pre-trained configurations that cannot handle fluctuating noise conditions, room acoustics, and/or speaker variability, causing reduced recognition accuracy. The existing technological problems can arise when these systems fail to analyze and/or determine the real-time changes in the environment, resulting in reduced recognition and inefficient resource usage. Method 450 of FIG. 4B can address these technological problems by incorporating real-time evaluations of multi-dimensional acoustic properties, updating neural network parameters during inference to adjust for environmental changes and speaker variability, thereby increasing the speed of the speech recognition process.

The method 450, at block 460, includes receiving an audio signal representing target speech of a target speaker and secondary speech of one or more secondary speakers. For example, the audio signal can be captured from a single microphone system in an environment with multiple speakers and/or multi-microphone system placed in an environment with multiple speakers. In this example, the audio signal can contain overlapping speech from the target speaker and one or more secondary speakers. In some implementations, the audio signal can include an acoustic characteristic corresponding to a room impulse response. That is, the room impulse response can represent at least one of a direct path or a reflected path in an environment to modify the target speech of the target speaker and the secondary speech of the one or more secondary speakers.

The method 450, at block 470, includes applying the audio signal as input to at least one neural network to cause the at least one neural network to generate a text representation of the target speech. For example, the processing circuits can process the audio signal through an encoder-decoder framework to isolate the target speech from the secondary speech. That is, the at least one neural network can be updated (e.g., trained, tuned) based at least on an acoustic characteristic of a plurality of environments and example audio data and example speech data from a plurality of speakers. In some implementations, the at least one neural network can include a first neural network to generate the text representation of the target speech and a second neural network to generate a text representation of the secondary speech of at least one secondary speaker of the one or more secondary speakers. Additionally, the processing circuitry can operate the first neural network and the second neural network in parallel. In some implementations, the text representation of the target speech can include predicted text corresponding to spoken words of the target speaker based at least on the audio signal. Additionally, the text representation of a secondary speech can include predicted text corresponding to spoken words of the one or more secondary speakers based at least on the audio signal.

The method 450, at block 480, includes outputting, using at least one of a display device or an audio output device, the text representation. For example, the text representation can be displayed on a screen as a real-time transcription of the target speech. In this example, the output device can also provide the transcribed text for the secondary speech. That is, the processing circuits can manage the output in real time to display or broadcast the transcriptions. In some implementations, the display device can be, but is not limited to, a tablet, computer monitor, mobile device, and/or any touchscreen interface. In some implementations, the audio output device can be, but is not limited to, a speaker, headphones, earpiece, and/or any voice assistant device. In some implementations, method 450 can further include applying the audio signal as input to the second neural network to cause the second neural network to generate the text representation of the secondary speech.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as large language models (LLMs), vision language models (VLMs), multi-modal language models (MMLMs), and/or other types of generative artificial intelligence (AI) can be implemented. Generally, the language models can process and generate text, visual, and multi-modal data to perform tasks such as text prediction, translation, and comprehension across various contexts. That is, the language models can use neural network architectures (e.g., transformer-based models) to analyze input data, generate outputs, and support applications in natural language processing, computer vision, and cross-modal analysis. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained on massive datasets and having architectures with large number of learnable network parameters (weights and biases)—such as millions or billions of parameters. The LLMs/VLMs/SLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/SLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 5A is a block diagram of an example generative language model system 500 suitable for use in implementing at least some implementations of the present disclosure. Generally, the example generative language model system 500 can process input data (e.g., text, audio) and generate predicted outputs (e.g., transcriptions, text responses, classifications) based on learned patterns from training data. That is, the generative language model system 500 can include one or more machine learning models (e.g., transformer models, neural networks) can be trained on datasets to perform tasks such as speech recognition, natural language understanding, and text generation. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which can include an LLM, a VLM, a multi-modal LM, etc.).

At a high level, the input processor 505 can receive an input 501 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 530 (e.g., LLM/VLM/MMLM/etc.). In some implementations, the input 501 includes plain text in the form of one or more sentences, paragraphs, and/or documents. Additionally or alternatively, the input 501 can include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 can combine text (or can omit text) with image data, audio data, video data, design data, USD data, and/or other types of input data, such as but not limited to those described herein. Taking raw input text as an example, the input processor 505 can prepare raw input text in various ways. For example, the input processor 505 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 can remove stopwords to reduce noise and focus the generative LM 530 on more meaningful content. The input processor 505 can apply text normalization, for example, by converting all characters to lowercase, removing accents, and/or or handling special cases like contractions or abbreviations to ensure consistency. These are just a few examples, and other types of input processing can be applied.

In some implementations, a RAG component 592 (which can include one or more RAG models, and/or can be performed using the generative LM 530 itself) can be used to retrieve additional information to be used as part of the input 501 or prompt. RAG can be used to enhance the input to the LLM/VLM/MMLM/etc. with external knowledge, so that answers to specific questions or queries or requests are more relevant—such as in a case where specific knowledge is required. The RAG component 592 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 501 can be generated using the query or input to the model (e.g., a question, a request, etc.) in addition to data retrieved using the RAG component 592. In some implementations, the input processor 505 can analyze the input 501 and communicate with the RAG component 592 (or the RAG component 592 can be part of the input processor 505, in implementations) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 can retrieve a prior stored conversation history—or at least a summary thereof—and include the prior conversation history along with the current ask/request as part of the input 501 to the generative LM 530.

The RAG component 592 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 592 and the embeddings of the chunks along with the embeddings of the query can be compared to identify the most similar/related embeddings to the query, which can be supplied to the generative LM 530 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 592 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 510 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy can depend on factors such as the language being processed, the task at hand, and/or characteristics of the training dataset. As such, the tokenizer 510 can convert the (e.g., processed) text into a structured format according to tokenization schema being implemented in the particular implementation.

The embedding component 520 can use any known embedding technique to transform discrete tokens into (e.g., dense, continuous vector) representations of semantic meaning. For example, the embedding component 520 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 501 can resize the data to a standard size compatible with format of a corresponding input channel and/or can normalize pixel values to a common range (e.g., 0 to 1) to ensure a consistent representation, and the embedding component 520 can encode the image data using any known technique (e.g., using one or more convolutional neural networks (CNNs) to extract visual features). In some implementations in which the input 501 includes audio data, the input processor 501 can resample an audio file to a consistent sampling rate for uniform processing, and the embedding component 520 can use any known technique to extract and encode audio features—such as in the form of a spectrogram (e.g., a mel-spectrogram). In some implementations in which the input 501 includes video data, the input processor 501 can extract frames or apply resizing to extracted frames, and the embedding component 520 can extract features such as optical flow embeddings or video embeddings and/or can encode temporal information or sequences of frames. In some implementations in which the input 501 includes multi-modal data, the embedding component 520 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 can apply an encoded representation of the input 501 to the generative LM 530, and the generative LM 530 can process the encoded representation of the input 501 to generate an output 590, which can include responsive text and/or other types of data.

As described herein, in some implementations, the generative LM 530 can be configured to access or use—or capable of accessing or using—plug-ins/APIs 595 (which can include one or more plug-ins, application programming interfaces (APIs), databases, data stores, repositories, etc.). For example, for certain tasks or operations that the generative LM 530 is not ideally suited for, the model can have instructions (e.g., as a result of training, and/or based on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 595 to the plug-in/API 595, the plug-in/API 595 can process the information and return an answer to the generative LM 530, and the generative LM 530 can use the response to generate the output 590. This process can be repeated—e.g., recursively—for any number of iterations and using any number of plug-ins/APIs 595 until an output 590 that addresses each ask/question/request/process/operation/etc. from the input 501 can be generated. As such, the model(s) can not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. Generally, the generative LM 530 can process mixed audio signals that include speech from multiple speakers and generate corresponding text representations for at least one (e.g., each) speaker, using an architecture to perform automatic speech recognition (ASR) in multi-speaker environments. That is, the generative LM 530 can be trained to process speech recognition tasks by processing mixed signals, identifying distinct speaker-specific components, and generating predicted text for both target and interfering speakers. For example, assume input text such as “Who discovered gravity” is tokenized (e.g., by the tokenizer 510 of FIG. 5A) into tokens such as words, and each token is encoded (e.g., by the embedding component 520 of FIG. 95A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 540 can convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 can generate a first token, and the generation mechanism 555 can apply the generated token as an input during a second pass. The process can repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 can output some decoded (e.g., vector) representation of the input being applied during a particular pass. The classifier 550 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 can select or sample a word or token based on a corresponding predicted probability (e.g., select the word with the highest predicted probability) and append it to the output from a previous pass, generating each word or token sequentially. The generation mechanism 555 can repeat the process, triggering successive decoder inputs and corresponding predictions until selecting or sampling a symbol or token that represents the end of the response, at which point, the generation mechanism 555 can output the generated response.

FIG. 5C is a block diagram of an example implementation in which the generative LM 530 includes a decoder-only transformer architecture. For example, the decoder(s) 560 of FIG. 5C can operate similarly as the decoder(s) 545 of FIG. 5B except each of the decoder(s) 560 of FIG. 5C omits the encoder-decoder self-attention layer (since there is no encoder in this implementation). As such, the decoder(s) 560 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 560. As with the decoder(s) 545 of FIG. 5B, each token (e.g., word) can flow through a separate path in the decoder(s) 560, and the decoder(s) 560, a classifier 565, and a generation mechanism 570 can use auto-regression to sequentially generate one token at a time until predicting a symbol or token that represents the end of the response. The classifier 565 and the generation mechanism 570 can operate similarly as the classifier 550 and the generation mechanism 555 of FIG. 5B, with the generation mechanism 570 selecting or sampling each successive output token based on a corresponding predicted probability and appending it to the output from a previous pass, generating each token sequentially until selecting or sampling a symbol or token that represents the end of the response. Generally, the generative LM 530 can process audio inputs and predict corresponding text outputs in a sequential (or parallel) manner by selecting the tokens based on learned probabilities from the input data. That is, the generative LM 530 can handle sequences of speech and generate text transcriptions token by token. These and other architectures described herein are meant simply as examples, and other suitable architectures can be implemented within the scope of the present disclosure.

### Example Computing Device

FIG. 6 is a block diagram of an example computing device(s) 600 suitable for use in implementing some implementations of the present disclosure. Generally, the example computing device(s) 600 can process audio signals, execute machine learning models (e.g., neural networks for speech recognition), and perform tasks related to automated speech recognition (ASR) in multi-speaker environments. That is, the computing device(s) 600 can execute various stages of the audio processing pipeline, including preprocessing, encoding, decoding, and generating text outputs, ensuring accurate transcription of speech from multiple speakers. Computing device 600 can include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one implementation, the computing device(s) 600 can comprise one or more virtual machines (VMs), and/or any of the components thereof can comprise virtual components (e.g., virtual hardware components). For non-limiting examples, one or more of the GPUs 608 can comprise one or more vGPUs, one or more of the CPUs 606 can comprise one or more vCPUs, and/or one or more of the logic units 620 can comprise one or more virtual logic units. As such, a computing device(s) 600 can include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some implementations, a presentation component 618, such as a display device, can be considered an I/O component 614 (e.g., if the display is a touch screen). As another example, the CPUs 606 and/or GPUs 608 can include memory (e.g., the memory 604 can be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 can represent one or more links or busses, such as an address bus, a data bus, a control bus, or a combination thereof. The interconnect system 602 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 606 can be directly connected to the memory 604. Further, the CPU 606 can be directly connected to the GPU 608. Where there is direct, or point-to-point connection between components, the interconnect system 602 can include a PCIe link to carry out the connection. In these examples, a PCI bus need not be included in the computing device 600.

The memory 604 can include any of a variety of computer-readable media. The computer-readable media can be any available media that can be accessed by the computing device 600. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 604 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 606 can be configured to execute at least some of the computer-readable instructions to control one or more components of the computing device 600 to perform one or more of the methods and/or processes described herein. The CPU(s) 606 can each include one or more cores (e.g., one, two, four, eight, twenty-eight, seventy-two, etc.) that are capable of handling a multitude of software threads simultaneously. The CPU(s) 606 can include any type of processor, and can include different types of processors depending on the type of computing device 600 implemented (e.g., processors with fewer cores for mobile devices and processors with more cores for servers). For example, depending on the type of computing device 600, the processor can be an Advanced RISC Machines (ARM) processor implemented using Reduced Instruction Set Computing (RISC) or an x86 processor implemented using Complex Instruction Set Computing (CISC). The computing device 600 can include one or more CPUs 606 in addition to one or more microprocessors or supplementary co-processors, such as math co-processors.

In addition to or alternatively from the CPU(s) 606, the GPU(s) 608 can be configured to execute at least some of the computer-readable instructions to control one or more components of the computing device 600 to perform one or more of the methods and/or processes described herein. One or more of the GPU(s) 608 can be an integrated GPU (e.g., with one or more of the CPU(s) 606 and/or one or more of the GPU(s) 608 can be a discrete GPU. In implementations, one or more of the GPU(s) 608 can be a coprocessor of one or more of the CPU(s) 606. The GPU(s) 608 can be used by the computing device 600 to render graphics (e.g., 3D graphics) or perform general purpose computations. For example, the GPU(s) 608 can be used for General-Purpose computing on GPUs (GPGPU). The GPU(s) 608 can include hundreds or thousands of cores that are capable of handling hundreds or thousands of software threads simultaneously. The GPU(s) 608 can generate pixel data for output images in response to rendering commands (e.g., rendering commands from the CPU(s) 606 received via a host interface). The GPU(s) 608 can include graphics memory, such as display memory, for storing pixel data or any other suitable data, such as GPGPU data. The display memory can be included as part of the memory 604. The GPU(s) 608 can include two or more GPUs operating in parallel (e.g., via a link). The link can directly connect the GPUs (e.g., using NVLINK) or can connect the GPUs through a switch (e.g., using NVSwitch). When combined together, each GPU 608 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 606 and/or the GPU(s) 608, the logic unit(s) 620 can be configured to execute at least some of the computer-readable instructions to control one or more components of the computing device 600 to perform one or more of the methods and/or processes described herein. In implementations, the CPU(s) 606, the GPU(s) 608, and/or the logic unit(s) 620 can discretely or jointly perform any combination of the methods, processes and/or portions thereof. One or more of the logic units 620 can be part of and/or integrated in one or more of the CPU(s) 606 and/or the GPU(s) 608 and/or one or more of the logic units 620 can be discrete components or otherwise external to the CPU(s) 606 and/or the GPU(s) 608. In implementations, one or more of the logic units 620 can be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 can include one or more receivers, transmitters, and/or transceivers that allow the computing device 600 to communicate with other computing devices via an electronic communication network, included wired and/or wireless communications. The communication interface 610 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 620 and/or communication interface 610 can include one or more data processing units (DPUs) to transmit data received over a network and/or through interconnect system 602 directly to (e.g., a memory of) one or more GPU(s) 608.

The I/O ports 612 can allow the computing device 600 to be logically coupled to other devices including the I/O components 614, the presentation component(s) 618, and/or other components, some of which can be built in to (e.g., integrated in) the computing device 600. Illustrative I/O components 614 include a microphone, mouse, keyboard, joystick, game pad, game controller, satellite dish, scanner, printer, wireless device, etc. The I/O components 614 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 can be include depth cameras, such as stereoscopic camera systems, infrared camera systems, RGB camera systems, touchscreen technology, and combinations of these, for gesture detection and recognition. Additionally, the computing device 600 can include accelerometers or gyroscopes (e.g., as part of an inertia measurement unit (IMU)) that allow detection of motion. In some examples, the output of the accelerometers or gyroscopes can be used by the computing device 600 to render immersive augmented reality or virtual reality.

The power supply 616 can include a hard-wired power supply, a battery power supply, or a combination thereof. The power supply 616 can provide power to the computing device 600 to allow the components of the computing device 600 to operate.

The presentation component(s) 618 can include a display (e.g., a monitor, a touch screen, a television screen, a heads-up-display (HUD), other display types, or a combination thereof), speakers, and/or other presentation components. The presentation component(s) 618 can receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that can be used in at least one implementations of the present disclosure. Generally, the example data center 700 can provide the computational infrastructure for processing audio data, executing ASR models, and supporting training and inference for neural networks used in multi-speaker environments. That is, the data center 700 can store the processing circuits, data storage, and networking resources necessary to perform the processing of real-time ASR and model updates across multiple systems. The data center 700 can include a data center infrastructure layer 710, a framework layer 720, a software layer 730, and/or an application layer 740.

As shown in FIG. 7, the data center infrastructure layer 710 can include a resource orchestrator 712, grouped computing resources 714, and node computing resources (“node C.R.s”) 716(1)-716(N), where “N” represents any whole, positive integer. In at least one implementation, node C.R.s 716(1)-716(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 716(1)-716(N) can correspond to a server having one or more of the above-mentioned computing resources. In addition, in some implementations, the node C.R.s 716(1)-7161(N) can include one or more virtual components, such as vGPUs, vCPUs, and/or the like, and/or one or more of the node C.R.s 716(1)-716(N) can correspond to a virtual machine (VM).

In at least one implementation, grouped computing resources 714 can include separate groupings of node C.R.s 716 housed within one or more racks (not shown), or many racks housed in data centers at various geographical locations (also not shown). Separate groupings of node C.R.s 716 within grouped computing resources 714 can include grouped compute, network, memory or storage resources that can be configured or allocated to support one or more workloads. In at least one implementation, several node C.R.s 716 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 712 can configure or otherwise control one or more node C.R.s 716(1)-716(N) and/or grouped computing resources 714. In at least one implementation, resource orchestrator 712 can include a software design infrastructure (SDI) management entity for the data center 700. The resource orchestrator 712 can include hardware, software, or some combination thereof.

In at least one implementation, as shown in FIG. 7, framework layer 720 can include a job scheduler 728, a configuration manager 734, a resource manager 736, and/or a distributed file system 738. The framework layer 720 can include a framework to support software 732 of software layer 730 and/or one or more application(s) 742 of application layer 740. The software 732 or application(s) 742 can respectively include web-based service software or applications, such as those provided by Amazon Web Services, Google Cloud and Microsoft Azure. The framework layer 720 can be, but is not limited to, a type of free and open-source software web application framework such as Apache Spark™ (hereinafter “Spark”) that can use distributed file system 738 for large-scale data processing (e.g., “big data”). In at least one implementation, job scheduler 728 can include a Spark driver to facilitate scheduling of workloads supported by various layers of data center 700. The configuration manager 734 can be capable of configuring different layers such as software layer 730 and framework layer 720 including Spark and distributed file system 738 for supporting large-scale data processing. The resource manager 736 can be capable of managing clustered or grouped computing resources mapped to or allocated for support of distributed file system 738 and job scheduler 728. In at least one implementation, clustered or grouped computing resources can include grouped computing resource 714 at data center infrastructure layer 710. The resource manager 736 can coordinate with resource orchestrator 712 to manage these mapped or allocated computing resources.

In at least one implementation, software 732 included in software layer 730 can include software used by at least portions of node C.R.s 716(1)-716(N), grouped computing resources 714, and/or distributed file system 738 of framework layer 720. One or more types of software can include, but are not limited to, Internet web page search software, e-mail virus scan software, database software, and streaming video content software.

In at least one implementation, application(s) 742 included in application layer 740 can include one or more types of applications used by at least portions of node C.R.s 716(1)-716(N), grouped computing resources 714, and/or distributed file system 738 of framework layer 720. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 734, resource manager 736, and resource orchestrator 712 can implement any number and type of self-modifying actions based on any amount and type of data acquired in any technically feasible fashion. Self-modifying actions can relieve a data center operator of data center 700 from making possibly bad configuration decisions and possibly avoiding underutilized and/or poor performing portions of a data center.

The data center 700 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 700. In at least one implementation, trained or deployed machine learning models corresponding to one or more neural networks can be used to infer or predict information using resources described above with respect to the data center 700 by using weight parameters calculated through one or more training techniques, such as but not limited to those described herein.

In at least one implementation, the data center 700 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 600 of FIG. 6—e.g., each device can include similar components, features, and/or functionality of the computing device(s) 600. In addition, where backend devices (e.g., servers, NAS, etc.) are implemented, the backend devices can be included as part of a data center 700, an example of which is described in more detail herein with respect to FIG. 7.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 600 described herein with respect to FIG. 6. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate a mixed audio signal based at least on speech of a first speaker and speech of at least one second speaker to which at least one acoustic characteristic of an environment is applied;
cause at least one neural network to generate an estimated output based at least on the mixed audio signal; and
update the at least one neural network based at least on the estimated output and ground-truth text corresponding to the speech of the first speaker.

2. The one or more processors of claim 1, wherein the at least one acoustic characteristic corresponds to a room impulse response, the room impulse response representing at least one of a direct path or a reflected path in the environment to modify the speech of the first speaker and the speech of the at least one second speaker.

3. The one or more processors of claim 1, wherein the one or more processors comprising processing circuitry are to:
cause the at least one neural network to generate a second estimated output comprising predicted text corresponding to spoken words of the at least one second speaker based at least on the mixed audio signal and the ground-truth text corresponding to the speech of the at least one second speaker.

4. The one or more processors of claim 3, wherein the at least one neural network comprises a first neural network to generate the estimated output and a second neural network to generate the second estimated output, the processing circuitry to operate the first neural network and the second neural network in parallel.

5. The one or more processors of claim 1, wherein the update of the at least one neural network comprises minimizing a cross-entropy loss between the estimated output and the ground-truth text corresponding to the speech of the first speaker, the cross-entropy loss determined based at least on a comparison between predicted text of the at least one neural network and the ground-truth text for the speech of the first speaker.

6. The one or more processors of claim 1, wherein training data preparation of the at least one neural network comprises:
selecting a first subset of a plurality of speakers in a speech corpus as a plurality of primary speakers;
selecting a second subset of the plurality of speakers in the speech corpus as a plurality of secondary speakers;
associating a plurality of first speech utterances of the first subset of the plurality of speakers with a primary speaker database; and
associating a plurality of second speech utterances of the second subset of the plurality of speakers with a secondary speaker database.

7. The one or more processors of claim 1, wherein the mixed audio signal is generated by applying a speech-to-interference energy ratio to combine selected speech of the first speaker with selected speech of the at least one second speaker, the speech-to-interference energy ratio corresponding to a range.

8. The one or more processors of claim 7, wherein training data preparation of the at least one neural network comprises:
combining a plurality of speech samples of at least one primary speaker with selected portions of speech from a plurality of secondary speakers to generate the mixed audio signal, the mixed audio signal comprising the speech-to-interference energy ratio corresponding to a range, wherein the ground-truth text corresponds to the speech of the at least one primary speaker in the mixed audio signal.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

10. One or more processors comprising processing circuitry to:
receive an audio signal representing target speech of a target speaker and secondary speech of one or more secondary speakers;
apply the audio signal as input to at least one neural network to cause the at least one neural network to generate a text representation of the target speech, the at least one neural network trained based at least on an acoustic characteristic of a plurality of environments and example audio data and example speech data from a plurality of speakers; and
output, using at least one of a display device or an audio output device, the text representation.

11. The one or more processors of claim 10, wherein the at least one neural network comprises a first neural network to generate the text representation of the target speech, and a second neural network to generate a text representation of the secondary speech of at least one secondary speaker of the one or more secondary speakers, the processing circuitry to operate the first neural network and the second neural network in parallel.

12. The one or more processors of claim 11, wherein the one or more processors comprising processing circuitry are to:
apply the audio signal as input to the second neural network to cause the second neural network to generate the text representation of the secondary speech.

13. The one or more processors of claim 12, wherein the text representation of the target speech comprises predicted text corresponding to spoken words of the target speaker based at least on the audio signal, and wherein the text representation of the secondary speech comprises predicted text corresponding to spoken words of the one or more secondary speakers based at least on the audio signal.

14. The one or more processors of claim 10, wherein the acoustic characteristic corresponds to a room impulse response, the room impulse response representing at least one of a direct path or a reflected path in an environment to modify the target speech of the target speaker and the secondary speech of the one or more secondary speakers.

15. A method, comprising:
generating a mixed audio signal based at least on speech of a first speaker and speech of at least one second speaker to which at least one acoustic characteristic of an environment is applied;
causing at least one neural network to generate an estimated output based at least on the mixed audio signal; and
updating one or more parameters of the at least one neural network based at least on the estimated output and ground-truth text corresponding to the speech of the first speaker.

16. The method of claim 15, wherein the at least one acoustic characteristic corresponds to a room impulse response, the room impulse response representing at least one of a direct path or a reflected path in the environment to modify the speech of the first speaker and the speech of the at least one second speaker.

17. The method of claim 15, further comprising:
causing the at least one neural network to generate a second estimated output comprising predicted text corresponding to spoken words of the at least one second speaker based at least on the mixed audio signal and the ground-truth text corresponding to the speech of the at least one second speaker.

18. The method of claim 17, wherein the at least one neural network comprises a first neural network to generate the estimated output and a second neural network to generate the second estimated output, wherein first neural network and the second neural network are operated in parallel.

19. The method of claim 15, wherein the update of the at least one neural network comprises minimizing a cross-entropy loss between the estimated output and the ground-truth text corresponding to the speech of the first speaker, the cross-entropy loss determined based at least on a comparison between predicted text of the at least one neural network and the ground-truth text for the speech of the first speaker.

20. The method of claim 15, wherein training data preparation of the at least one neural network comprises:
selecting a first subset of a plurality of speakers in a speech corpus as a plurality of primary speakers;
selecting a second subset of the plurality of speakers in the speech corpus as a plurality of secondary speakers;
associating a plurality of first speech utterances of the first subset of the plurality of speakers with a primary speaker database; and
associating a plurality of second speech utterances of the second subset of the plurality of speakers with a secondary speaker database.
